(19) United States
(12) Patent Application Publication
(10) Pub. No.: US 2006/0187262 A1
(43) Pub. Date: Aug. 24, 2006

(54) Inkjet Head And A Method Of Manufacturing An Inkjet Head

(75) Inventor: Atsushi Ito, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi, Aichi-ken (JP)

(21) Appl. No.: 11/276,252

(22) Filed: Feb. 21, 2006

(30) Foreign Application Priority Data
Feb. 21, 2005 (JP) 2005044299

(51) Int. Cl. B41J 2/04

(52) U.S. Cl. 347/54

(57) ABSTRACT

An inkjet head having improved print image quality is provided. The inkjet head includes a nozzle plate having nozzles for discharging ink. Swelled portions are arranged that project from the outer surface of the nozzle plate that is the surface facing a printing medium when the inkjet head is in use. The nozzle plate has nozzles that penetrate the outer surface and inner surface of the nozzle plate. The outer surface side openings of the nozzles are disposed within the flat top surfaces of the swelled portions. This type of inkjet head does not require grinding of the entire surface of the outer surface of the nozzle plate, when the periphery of the outer surface side openings of the nozzles is to be flattened. If only the flat top surfaces of the swelled portions are ground, the periphery of the outer surface side openings of the nozzles can be flattened. The time needed to flatten the periphery of the outer surface side openings of the nozzles can be shortened. When the outer surface side openings of the nozzles are to be flattened, the outer peripheral edge of the outer peripheral side openings of the nozzles are not subject to unnecessary grinding. Thus, the outer peripheral edges of the outer surface side openings of the nozzles can be made sharp. The outer surface side openings of the nozzles which have sharp edges can stably discharge ink. An inkjet head having improved print quality can be achieved.

### CROSS REFERENCE TO RELATED APPLICATION

This application claims priority to Japanese Patent Application No. 2005-044299 filed on Feb. 21, 2005, the contents of which are hereby incorporated by reference into the present application.

### BACKGROUND OF THE INVENTION

1. Field of the Invention

The present invention relates to an inkjet head and a method of manufacturing an inkjet head.

2. Description of the Related Art

Inkjet heads are known in the prior art that comprise a nozzle plate in which nozzles are formed, and which discharge ink from the nozzles in order to print images on a printing medium. The nozzle plate is disposed on a surface of the inkjet head that faces the printing medium when the inkjet head is in use. One surface of the nozzle plate faces the printing medium when the inkjet head is in use. In the present description, the surface of the nozzle plate that faces the printing medium will be referred to as the outer surface. The other surface of the nozzle plate that is opposite to the outer surface will be referred to as the inner surface.

The nozzles penetrate the substantially flat nozzle plate from the inner surface to the outer surface. With a conventional inkjet head, the openings of the nozzles arranged on the outer surface of the nozzle plate are open in the same plane of the outer surface of the nozzle plate. The openings of the nozzles on the outer surface discharge ink.

Japan Patent Application Publication No. 2004-160786 discloses one example of a manufacturing method for this type of inkjet head. In this disclosed technology, a punch will be pressed from the inner surface of the nozzle plate. The tip of the punch is pressed beyond the outer surface of the nozzle plate. As a result, recessed portions will be formed in the inner surface of the nozzle plate. The bottom portions of the recessed portions will be positioned beyond the outer surface. Hollow protrusions will be formed on the outer surface side of the nozzle plate that covers the bottom portions of the recessed portions. The entire outer surface of the nozzle plate will be flattened, and the protrusions removed. When the protrusions are removed, the bottom portions of the recessed portions will also be removed. Then the nozzles are formed that penetrate the nozzle plate from the inner surface to the outer surface. Other plates that form ink passages for supplying ink to the nozzles, and actuator units that control the discharge of ink, will be assembled with the nozzle plate in which the nozzles are formed. The inkjet head will be complete.

### BRIEF SUMMARY OF THE INVENTION

The entire outer surface of the nozzle plate will be flattened and the protrusions will be removed by mechanical grinding, for example, a known lapping and polishing process or the like. A grinding tool such as a lapping plate or the like will be used for mechanical grinding. When the entire outer surface of the nozzle plate will be ground by lapping and polishing process, the entire outer surface will be slid on the rotating lapping plate while abrasive slurries are being supplied on the lapping plate. The protrusions will be removed by means of the grinding, and the nozzle plate will be formed having the outer surface side nozzle openings that are open on the entirely flattened outer surface of the nozzle plate.

A long period of time will be needed to grind and flatten the entire outer surface of the nozzle plate. During grinding, when the protrusions begin to be removed and the openings of the nozzles on the outer surface side begin to be formed, the rotating lapping plate will be simultaneously slid over the outer surface and the openings. When the rotating lapping plate is slid over the outer surface and the openings simultaneously for a long period of time, the outer periphery of the openings will be unnecessarily ground due to warping of the rotating lapping plate and the abrasive slurries flowing into the openings. The outer peripheral edges of the openings will become blunted. When the outer peripheral edges of the openings of the nozzles on the outer surface side, are blunted, a phenomenon will occur in which the tails of ink drops that are discharged from the openings will be dragged and curved by the blunt edges. The ink drops cannot be stably discharged. As a result, image quality of the printed image may not be improved. With an inkjet head having outer surface side nozzle openings that open on the entirely flattened outer surface of the nozzle plate, it is difficult to form sharp outer peripheral edges on the outer surface side openings of the nozzle. In other words, with a conventional inkjet head, it is difficult to improve image quality of the printed image.

An object of the present invention is to provide technology in an inkjet head that will improve the image quality of the printed image. Thus, an inkjet head will be provided that is able to allow sharp outer peripheral edges to be formed on the outer surface side openings of the nozzle that penetrate the nozzle plate. A manufacturing method is provided for an inkjet head having the nozzle plate in which the outer peripheral edges of the outer surface side openings of the nozzle are sharp.

In an inkjet head having a nozzle plate according to this invention, the nozzle plate includes an outer surface, an inner surface, a swelled portion and a nozzle. The outer surface faces a printing medium when the inkjet head is in use. The inner surface is the surface opposite to the outer surface. The swelled portion is formed on the outer surface. The swelled portion has a top flat surface. The nozzle penetrates the nozzle plate from the outer surface to the inner surface. An opening of the nozzle at the outer surface is disposed within a top flat surface of the swelled portion.

The number of nozzles formed in the nozzle plate is not limited to one. A plurality of nozzles may be formed in the nozzle plate.

According to the aforementioned inkjet head, the opening of the nozzle on the outer surface side, ink are discharged from the opening, are disposed within the top flat surface of the swelled portion formed on the outer surface of the nozzle plate. The nozzle that penetrates the nozzle plate between the inner surface and the outer surface can, for example, be formed as follows. As noted above, a punch will be driven from the inner surface of the nozzle plate to form recessed portion in the inner surface of the nozzle plate. A protrusion having an inner space will be formed on the outer surface side of the nozzle plate. The top portion of the protrusion will be removed, while leaving a foot of the protrusion, until the inner space is exposed. A top flat surface will be formed on the foot. By removing the top portion of the protrusion until the inner space is exposed, the opening of the nozzle on the outer surface side through which ink is discharged will be formed within the top flat surface of the foot. The foot being leaved on the outer surface side of the nozzle plate corresponds to the aforementioned swelled portion. In the alternative, a penetrating hole (corresponding to a nozzle) will be formed in one step, by means of press working or the like, so as to form outer surface side nozzle openings on the top flat surface of the swelled portions. Then, the top flat surface of the swelled portions will be ground in order to remove jaggies from the outer surface side nozzle openings that are produced when the penetrating hole is formed. In either case, only the top flat surface of the swelled portion should be ground in order to flatten the area around the outer surface side nozzle opening. The entire outer surface of the nozzle plate need not be ground. The time needed for grinding can be shortened. As a result, the peripheries of the outer surface side nozzle opening for discharging ink will not be excessively ground. The peripheral edge of the outer surface side nozzle opening can be made sharp. When the peripheral edge of the outer surface side nozzle opening for discharging ink is made sharp, ink drops can be stably discharged. The image quality of printed images can be improved. By disposing the outer surface side nozzle opening, ink are discharged from the opening, within the top flat surface of the swelled portion formed on the outer surface of the nozzle plate, an inkjet head that improves the image quality of printed images can be achieved.

A method of manufacturing an inkjet head comprinsing a nozzle plate having an inner surface and an outer surface according to this invention includes the steps of driving a punch into the nozzle plate to form a protrusion on the outer surface of the nozzle plate, and removing a top portion of the protrusion to form a nozzle. In the step of driving the punch, the punch drives into the nozzle plate from the inner surface of the nozzle plate toward the outer surface of the nozzle plate until the tip of the punch proceeds beyond the original outer surface so that the protrusion having an inner space is formed on the outer surface. In the step of removing the top portion of the protrusion, the top portion of the protrusion is removed until the inner space is exposed, in order to leave a foot of the protrusion and to form a top flat surface having an opening within the top flat surface. By the step of removing the top portion of the protrusion, a nozzle penetrating the nozzle plate with the opening within the top flat surface of the leaving foot is formed.

The number of protrusions formed in the nozzle plate is not limited to one. A plurality of protrusions may be formed on the outer surface of the nozzle plate.

According to the aforementioned method, protrusion having an inner space will be formed on the outer surface of the nozzle plate due to the step of driving the punch into the nozzle plate. Due to the step of removing the top portion of the protrusion, the top portion of the protrusion will be removed, while leaving the foot of the protrusion, until the inner space is exposed at the outer surface side of the nozzle plate. Due to this step, the inner space will become nozzle that penetrates between the outer surface and the inner surface of the nozzle plate. The outer surface side nozzle opening will be formed within the top flat surface of the foot. The foot corresponds to the aforementioned swelled portion. In other words, nozzle can be formed that penetrates between the inner surface and the outer surface, and have outer surface side opening within t*e top flat surface of the swelled portion formed on the outer surface side.

When the top portion of the protrusion is ground, the foot of the protrusion will leave on the outer surface of the nozzle plate. Because of that, the entire outer surface of the nozzle plate need not be ground. Because the portion to be ground is limited to the top portion of the protrusion, grinding can be performed in a short period of time. Outer surface side nozzle opening on the outer surface side of the nozzle plate for discharging ink can be formed in a short period of time. Because grinding can be performed in a short period of time, too much of grinding need not be performed on the top flat surface of the foot of the protrusion. The outer peripheral edges of the outer surface side nozzle opening can be made sharp. Uniformly shaped ink drops will be stably discharged from outer surface side opening that have sharp edge on the outer periphery thereof. An inkjet head that improves the image quality during printing can be manufactured.

### BRIEF DESCRIPTION OF THE DRAWINGS

FIG. 1 shows a perspective view of an inkjet head of a first embodiment.

FIG. 2 shows a cross section of the inkjet head corresponding to line II-II shown in FIG. 1.

FIG. 3 shows a plan view of a head main unit seen from the upper surface thereof.

FIG. 4 is an enlarged plan view of the region surrounded with a dotted line in FIG. 3.

FIG. 5 is a cross section of the head main unit corresponding to line V-V shown in FIG. 4.

FIG. 6 shows a plan view of a nozzle plate of the first embodiment.

FIG. 7 shows a partial enlarged cross section of the area around a nozzle of the nozzle plate shown in FIG. 6.

FIG. 8a is an enlarged cross section of the region surrounded with a dotted line in FIG. 5.

FIG. 8b is a plan view of an individual electrode.

FIG. 9 is a flowchart that shows the manufacturing steps of the inkjet head of the first embodiment.

FIGS. 10(a) to (c) describe the manufacturing steps of the nozzle plate of the embodiment. FIG. 10(a) shows the nozzle plate prior to forming a nozzle. FIG. 10(b) shows a protrusion formed in the nozzle plate. FIG. 10(c) shows a nozzle formed in the nozzle plate.

FIGS. 11(a) to (d) describe the steps in forming a water-repel lent film on the nozzle plate. FIG. 11(a) shows a photo-curable resin coated on the outer surface of the nozzle plate. FIG. 11(b) shows a columnar cured resin formed in a portion of the outer surface side of the nozzle. FIG. 11(c) shows a water-repellent film formed on the outer surface of the nozzle plate. FIG. 11(d) shows the columnar cured resin removed.

FIG. 12a is an enlarged plan view in the area around the outer surface side opening of the nozzle of the first embodiment.

FIG. 12b is an enlarged plan view in the area around the outer surface side opening of a conventional nozzle.

FIG. 13 shows a partial enlarged cross section of the area around a nozzle of a nozzle plate of a second embodiment.

FIG. 14 shows a partial enlarged cross section of the area around a nozzle of a nozzle plate of a third embodiment.

FIG. 15 shows a partial enlarged cross section of the area around a nozzle of a nozzle plate of a fourth embodiment.

### DETAILED DESCRIPTION OF THE INVENTION

Preferable technical characteristics of the invention are described below.

It is preferred that the swelled portion is formed by driving a punch into the nozzle plate from the inner surface toward the outer surface of the nozzle plate.

By driving a punch from the inner surface of the nozzle plate toward the outer surface, the swelled portion can be easily formed. An inkjet head improving print image quality can be inexpensively provided.

It is preferred that the swelled portion gradually changes its height from the outer surface of the nozzle plate around the top flat surface.

According to the aforementioned technical characteristics, when ink and the like that has been adhered on the outer surface of the nozzle plate is wiped up with a wiper or the like, the wiper can smoothly move over a surface whose height gradually changes from the outer surface to the top flat surfaces of the swelled portion. The wiper can smoothly move without becoming caught on the swelled portion formed on the outer surface of the nozzle plate. The depletion of the wiper can be reduced. In addition, ink adhered around the peripheries of the outer surface side nozzle opening that discharges ink can be reliably wiped up.

It is preferred that a contour line of the nozzle in a cross section including a nozzle centerline continues to the inner surface of the nozzle plate without an edge therebetween.

Ink will flow from the inner surface side opening of the nozzle plate into the nozzle, and be discharged from the outer surface side opening. According to the aforementioned technical characteristics, ink can flow smoothly from the inner surface side of the nozzle plate into the nozzle.

It is preferred that the diameters of the opening of the nozzle at the inner surface is larger than the diameter of the opening of the nozzle at the outer surface.

According to the aforementioned technical characteristics, the flow rate of ink that flows from the inner surface side opening of the nozzle and discharged from the outer surface side opening can be increased. The flow rate at which ink is discharged can be increased. When the flow rate at which ink is discharged is increased, the ink can be more stably discharged.

More particularly, when the diameter of the inner surface side opening of the nozzle are formed larger than the diameter of the outer surface side opening, the nozzle may be formed as follows.

(a) A contour line of the nozzle in a cross section including a nozzle centerline may include a first curved line, a first straight line, a second curved line and a second straight line. The first curved line extends from the inner surface of the nozzle plate. The first straight line extends from the first curved line. The second curved line extends from the first straight line. The second straight line extends from the second curved line. The first straight line extends toward the outer surface of the nozzle plate while approaching the nozzle centerline. The second straight line is perpendicular to the outer surface of the nozzle plate. The first curved line, the first straight line, the second curved line and the second straight line extend without edges at boundaries therebetween.

(b) A contour line of the nozzle in a cross section including a nozzle centerline may include a first curved line, a straight line and a second curved line. The first curved line extends from the inner surface of the nozzle plate. The straight line extends from the first curved line. The second curved line extends from the straight line. The straight line extends toward the outer surface of the nozzle plate while approaching the nozzle centerline. The second curved line extends toward the outer surface of the nozzle plate while approaching the nozzle centerline. The first curved line, the straight line and the second curved line extend without edges at boundaries therebetween.

(c) A contour line of the nozzle in a cross section including a nozzle centerline may include a first curved line, a first straight line, a second curved line and a second straight line. The first curved line extends from the inner surface of the nozzle plate. The first straight line extends from the first curved line. The second curved line extends from the first straight line. The second straight line extends from the second curved line. The first straight line extends toward the outer surface of the nozzle plate while approaching the nozzle centerline. The second straight line extends toward the outer surface of the nozzle plate while approaching the nozzle centerline. The first curved line, the first straight line, the second curved line and the second straight line extend without edges at boundaries therebetween.

(d) A contour line of the nozzle in a cross section including a nozzle centerline may include a curved line, a first straight line and a second straight line. The curved line extends from the inner surface of the nozzle plate. The first straight line extends from the first curved line. The second straight line extends from the first straight line. The first straight line extends toward the outer surface of the nozzle plate while approaching the nozzle centerline. The second straight line is perpendicular to the outer surface of the nozzle plate. The curved line, and the first straight line extend without edges at boundaries therebetween.

In any of the nozzles of the aforementioned cases, the diameter of the inner surface side opening of the nozzle is formed larger than the diameter of the outer surface side opening.

In any of the aforementioned cases, in the cross section that includes the centerline of the nozzle, the contour of the nozzle has the first curved line that extends from the inner surface of the nozzle plate (the “curved line” in case (d) corresponds to the first curved line in other cases). Due to the first curved line, ink can smoothly flow into the nozzle from the inner surface side of the nozzle plate.

In any of the aforementioned cases, in the cross section that includes the centerline of the nozzle, the contour of the nozzle has the first straight line (the “straight line” in case (b) corresponds to the first straight line in other cases). The first straight line extends toward the outer surface of the nozzle plate as it approaches the centerline of the nozzle. The first straight line portion of the nozzle will form a tapered hole that tapers toward the outer surface of the nozzle plate. The flow rate of ink that passes through the tapered hole will increase. The discharging speed of ink that is discharged from the outer surface side opening of the nozzle can be increased. An inkjet head that more stably discharges ink can be provided.

In cases (a), (b), and (c), in the cross section that includes the centerline of the nozzle, the contour of the nozzle will smoothly extend so that each of the straight lines and each of the curved lines that form the contour of the nozzle will not have corners. Therefore, the flow of ink will not be disturbed, and can smoothly flow inside the nozzle.

In the aforementioned cases (a) and (d), in the cross section that includes the centerline of the nozzle, the contour of the nozzle has a second straight line. The second straight line is perpendicular to the outer surface of the nozzle plate. The second straight line portion of the nozzle will form a columnar hole. By passing ink through the columnar hole, the flow thereof will be stable. Ink having a stabilized flow can be discharged.

In the aforementioned case (b), in the cross section that includes the centerline of the nozzle, the contour of the nozzle has a second curved line. The second curved line portion of the nozzle will form a curved hole that tapers toward the outer surface of the nozzle plate. The flow rate of ink that passes through the curved hole will increase. The discharging speed of ink that is discharged from the outer surface side opening of the nozzle can be further increased.

In the aforementioned case (c), in the cross section that includes the centerline of the nozzle, the contour of the nozzle has a second straight line. The second straight line portion of the nozzle will form a tapered hole that tapers toward the outer surface of the nozzle plate. The flow rate of ink that passes through the tapered hole will further increase. The discharging speed of ink that is discharged from the outer surface side opening of the nozzle can be further increased.

In the aforementioned case (d), in the cross section that includes the centerline of the nozzle, the contour of the nozzle may extend so that the first straight line and second straight line may have corners. They need not smoothly continued. The contour of the nozzle in the cross section that includes the centerline of the nozzle is simple. This type of nozzle can be easily manufactured.

The nozzle having each of the aforementioned contours in case (a) to (d) can be formed by driving a punch, the punch has a cross sectional shape that corresponds to each of the aforementioned contours in case (a) to (d), from the inner surface side of the nozzle plate.

More specifically, the punch may have a tapered shoulder so that, when the punch drives into the nozzle plate from the inner surface side, the tapered shoulder may form a contour line of the nozzle in a cross section including a nozzle centerline continues to the inner surface of the nozzle plate without an edge therebetween.

In order to remove the top portion of the protrusion, a lapping and polishing process may be applied.

The lapping and polishing process allows only the top portion of the protrusion to be removed in a short period of time, without grinding the outer surface of the nozzle plate.

It is preferred that a water-repellent film is formed on the outer surface of the nozzle plate. More specifically, in order to form the water-repellent film, the above manufacturing method may further include the steps of coating a photo-curable resin, radiating light, removing uncured photo-curable resin, forming a water-repellent film and removing the columnar cured resin. At the photo-curable resin coating step, the photo-curable resin is coated on the outer surface of the nozzle plate to fill a portion of the nozzle at the outer surface side with the photo-curable resin. At the light radiating step, light is radiated at the inner surface of the nozzle plate to form a columnar cured resin that fills the portion of nozzle at the outer surface side. The columnar cured portion is formed to extend beyond the outer surface. At the uncured photo-curable resin removing step, uncured photo-curable resin on the outer surface uncured by the light radiating step is removed. At the water-repellent film forming step, the water-repellent film is formed on the outer surface.

Preferably, the photo-curable resin is coated so that the thickness of the photo-curable resin is no more than the diameter of the opening of the nozzle at the outer surface.

Preferably, the water-repellent film may be formed by an electroplating process.

According to the aforementioned technical characteristics, the columnar cured resin having the same diameter as the inner diameter of the outer surface side opening of the nozzle can be formed in the outer surface side portion of the nozzle by means of a photo-curable resin. The columnar cured resin will be formed so as to extend outward from the outer surface side opening of the nozzle. A water-repellent film will be formed on the outer surface of the nozzle plate around the periphery of the columnar cured resin. Because a columnar cured resin that extends outward from the outer surface side opening is formed, the water-repellent film will not be formed at the outer surface side opening. Then, the columnar cured resin will be removed. A water-repellent film having a hole that is in the same position and has the same shape as the outer surface side opening can be formed on the outer surface of the nozzle plate. Ink will rarely adhere to the edge of the outer surface side opening of a nozzle that discharges ink. Furthermore, the hole in the water-repellent film is the same shape as the outer surface side opening of the nozzle in the film thickness direction as well. Thus, ink drops that are discharged from the outer surface side opening of the nozzle will be discharged without interference from the water-repellent film. A water-repellent film that does not hinder ink discharging can be formed. The water-repellent film can, for example, be formed by means of an electroplating process.

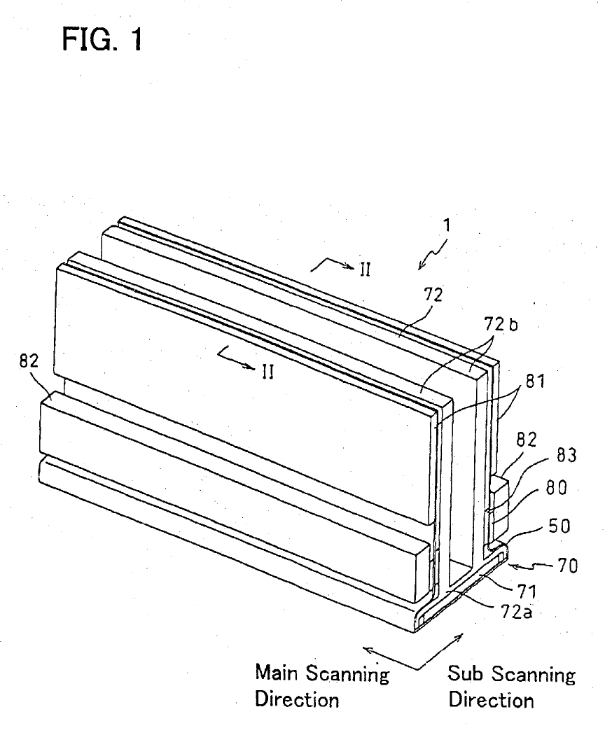

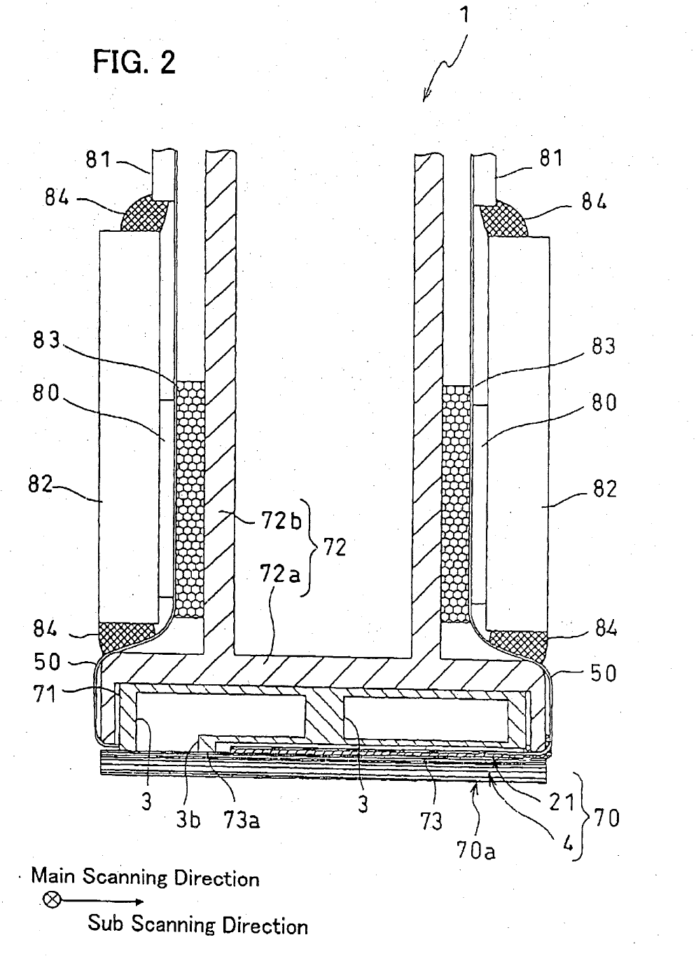

Preferred embodiments of the present invention will be described with reference to the attached drawings.

<First embodiment> First, an overview of an inkjet head will be described. FIG. 1 is a perspective exterior view of inkjet head 1 according to the present embodiment. FIG. 2 is a cross sectional view of inkjet head 1 that corresponds to line II-II of FIG. 1. Inkjet head 1 has head main unit 70, base block 71, holder 72, driver IC 80, circuit plates 81, and heat sinks 82.

Head main unit 70 is formed such that the bottom surface thereof is substantially rectangular, as shown in FIG. 1. For convenience, as shown in FIG. 1, the long direction of head main unit 70 will be referred to as the main scanning direction, and the short direction will be referred to as the sub scanning direction. An ink plate described below (not shown in FIG. 1) is disposed on the lower surface of head main unit 70. A plurality of nozzles (not shown in FIG. 1) that discharge ink to a printing medium is arranged on the ink plate.

Inkjet head 1 will move in the main scanning direction or the sub scanning direction relative to the printing medium such as paper or the like (not shown in the drawings), while discharging ink from the nozzles to print text and/or images.

As shown in FIG. 2, head main unit 70 includes passage unit 4 in which ink passages are formed, and a plurality of actuator units 21 that are adhered to the upper surface of passage unit 4 by means of an epoxy type of thermosetting adhesive. FIG. 2 is a cross sectional view, and illustrates only one actuator unit 21. The lower surface of passage unit 4 is ink discharging surface 70a on which a plurality of nozzles (not shown in FIGS. 1 and 2) that discharge ink is arranged. The nozzles will be described in detail below.

Flexible printed circuits (FPC) 50 are joined to the upper surface of actuator units 21. In FIG. 2, FPC 50 are pulled out from the left side or right side of actuator unit 21, and bend while extending upward.

Base block 71 is made of a metal material such as, for example, stainless steel or the like. Base block 71 is disposed above base unit 70. Two ink chambers 3 are formed in the interior of base block 71. Ink chambers 3 inside base block 71 are substantially square hollow regions that extend in the main scanning direction of base block 71. Ink chambers 3 will be supplied ink from an ink tank (not shown in the drawings) disposed on the exterior via an opening (not shown in the drawings) arranged in the end portions of ink chambers 3. Ink chambers 3 will always be filled with ink. Ten number of ink chamber holes 3b (only one ink chamber hole 3b is shown in FIG. 2) that supply ink to head main unit 70 will be arranged in two rows along the main scanning direction as described below.

Projected portions 73a (only one projected portion 73a is shown in FIG. 2) are formed on the lower surface of base block 71 and around ink chamber holes 3b. Projected portion 73a is projected downward more than the periphery of the lower surface of base block 71. Base block 71 is in contact with the upper surface of passage unit 4 only at the lower surface of projected portions 73a. Because of that, a space will be formed between base block 71 and head main unit 70, in regions other than the projected portions 73a. Actuator units 21 and FPC 50 will be disposed in the space.

Holder 72 includes holding portion 72a that holds base block 71, and a pair of holder walls 72b that extend upward from the upper surface of holder portion 72a. Each of holder walls 72b extends along the main scanning direction. A pair of holder walls 72b is disposed with predetermined distance between both holder walls 72b along sub scanning direction. Base block 71 is fixed inside a recess formed in the lower surface of holder portion 72a of the holder 72. FPC 50 are electrically connected to actuator units 21 by solder. FPC 50 are pulled out from the space between base block 71 and actuator units 21. FPC 50 are attached on the side surface of holder walls 72b via resilient material 83 such as a sponge or the like. FPC 50 are extend upward along the surface of each holder walls 72b. Driver IC 80 is attached on FPC 50 that is disposed on the surface of holder walls 72b. FPC 50 are electrically connected to driver IC 80 by solder. FPC 50 transmit drive signals from driver IC 80 to actuator units 21.

Heat sinks 82 that are substantially square in shape are attached to the outer surfaces of driver IC 80. In this way, heat generated by driver IC 80 can be efficiently dissipated. Circuit plates 81 are attached to the outer sides of FPC 50. Circuit plates 81 are disposed above driver IC 80 and heat sinks 82. Seal members 84 are filled respectively between the upper ends (upper surfaces) of the heat sinks 82 and the circuit plates 81. Seal members 84 are also filled respectively between the lower ends (lower surfaces) of heat sinks 82 and FPC 50. Seal members 84 prevent dirt and the like from intruding into the interior of the main portion of inkjet head 1.

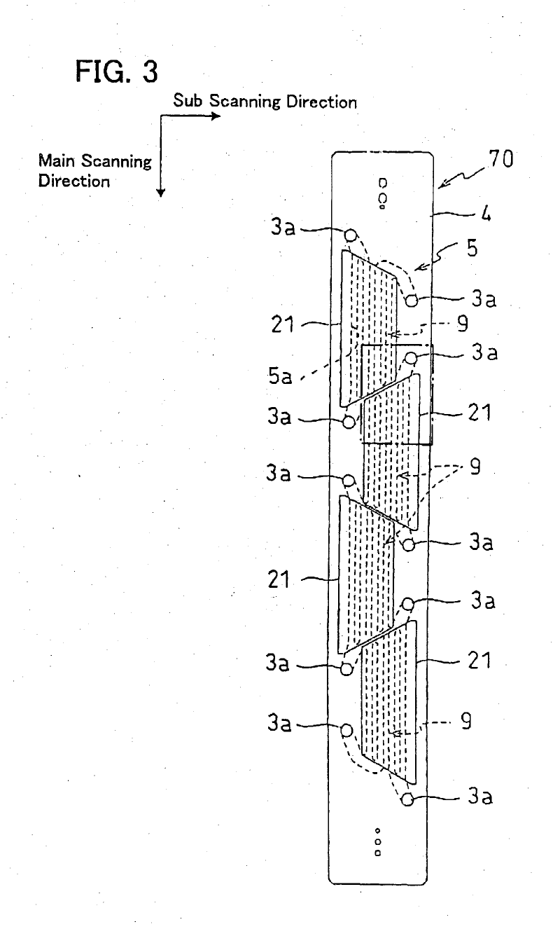

FIG. 3 is a plan view of head main unit 70 viewed from the upper surface thereof. As shown in FIG. 3, passage unit 4 has a flat rectangular shape that extends in the main scanning direction. Ten number of passage unit openings 3a are formed on the upper surface of passage unit 4. Passage unit openings 3a are arranged in two lows in the main scanning direction. Each of lows includes five number of passage unit openings 3a. Passage unit openings 3a arranged in each row are disposed in shifted positions in the main scanning direction so that each two of passage unit openings 3a are not aligned in a straight line in the sub scanning direction.

Each of passage unit openings 3a is connected to each corresponding ink chamber opening 3b. In other words, each of passage unit openings 3a and each corresponding ink chamber opening 3b are arranged so as to be in the same position when viewed in the plan perspective.

Manifold passages 5 arranged inside passage unit 4 are illustrated with broken lines in FIG. 3. Ink that is stored in ink chambers 3 of base block 71 will be supplied via ink chamber openings 3b and passage unit openings 3a to the manifold passages 5. Manifold passages 5 branch into a plurality of sub-manifold passages 5a that extend parallel to the main scanning direction of passage unit 4.

Four actuator units 21 whose planar shapes are trapezoidal are adhered to the upper surface of passage unit 4. Each actuator unit 21 is disposed so that the parallel sides of the trapezoids are parallel to the main scanning direction of passage unit 4. In addition, as shown in FIG. 3, adjacent actuator units 21 are alternately disposed in the direction of the trapezoids, such that the adjacent diagonal lines between two adjacent trapezoids are parallel with each other. The positions of adjacent actuator units 21 are also alternately shifted in the sub scanning direction, so that passage unit openings 3a do not overlap with actuator units 21. In other words, each adjacent actuator units 21 are disposed so that the diagonal edges of the trapezoids partially overlap in the sub scanning direction. Due to this arrangement, there will be no overlap with passage unit openings 3a and actuator units 21, and actuator units 21 having large surface areas can be disposed on the upper surface of passage unit 4.

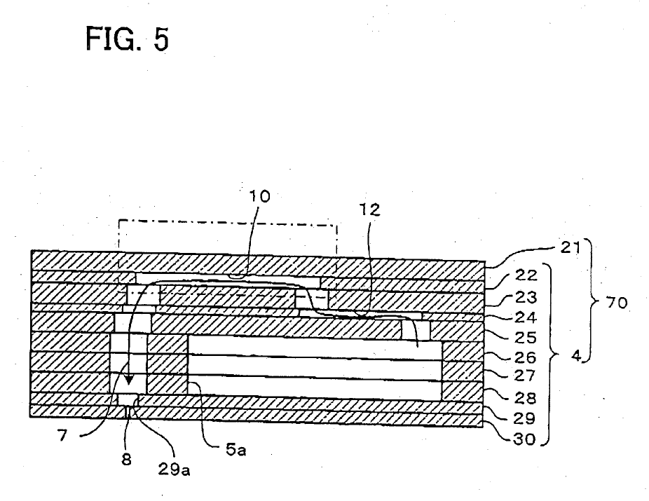

On the ink discharging surface 70a (see FIG. 2) that is the bottom surface of head main unit 70, the regions correspond to each trapezoid region of each actuators 21 will be referred to as ink discharging regions. As described below, a large number of nozzles 8 (not shown in FIG. 3) having extremely small diameters for discharging ink are arranged in each ink discharging region. A large number of extremely small pressure chambers 10 (not shown in FIG. 3) are formed on the upper surface of passage unit 4. The upper surface is the surface opposed to actuator units 21. Each pressure chamber corresponds to each nozzle 8. Because the nozzles 8 and pressure chambers 10 are extremely small, illustration thereof is omitted in FIG. 3. They will be described in detail below in FIG. 5. A pressure chamber group 9 is formed. Each pressure chamber group 9 consists of pressure chambers 10 correspond to the nozzles 8 disposed in each ink discharging region. In other words, the planar trapezoidal shape of each actuator unit 21 is sized to cover the large number of pressure chambers 10 that constitute each pressure chamber group 9. In addition, the planer shape of each actuator unit 21, the planar shape of each pressure group 9 corresponding to each actuator unit 21 and ink discharging region corresponding to each actuator unit 21 are similar. In other words, in the plan view of FIG. 3, each trapezoidal region that is formed by each actuator unit 21 substantially matches the shape of each corresponding pressure chamber group 9, and substantially matches the corresponding ink discharging region.

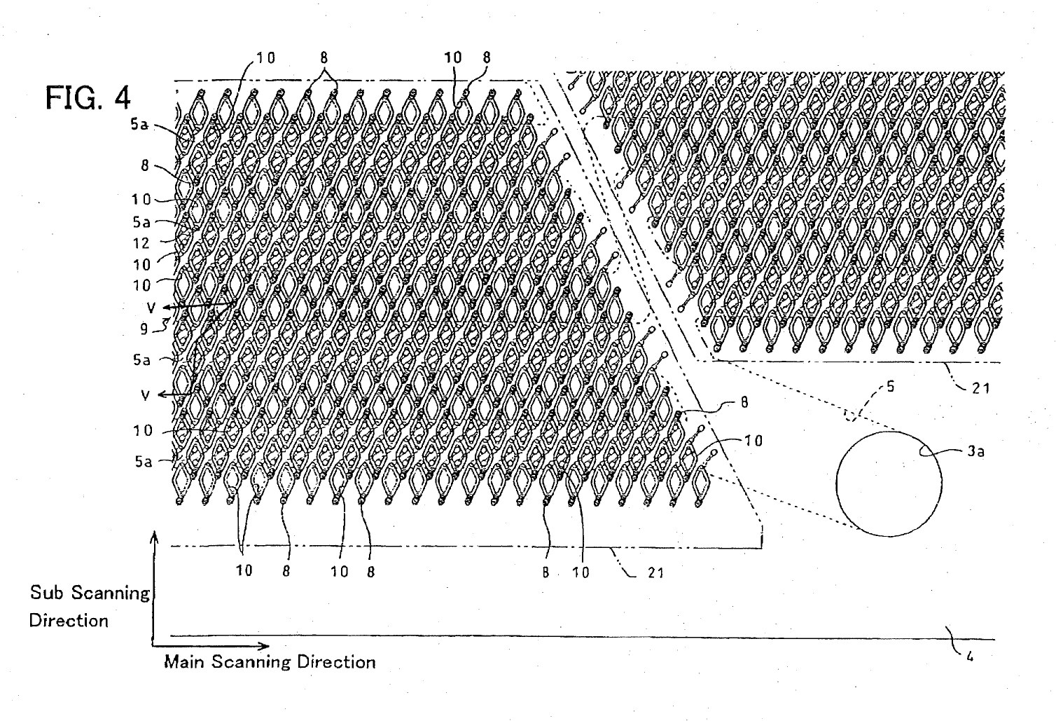

FIG. 4 is an enlarged plan view of a region that is surrounded with the dotted lines in FIG. 3. As shown in FIG. 4, four sub-manifold passages 5a extend in the region that are opposed to actuator units 21 inside the passage unit 4, and parallel with the main scanning direction of passage unit 4. A large number of pressure chambers 10 whose planar shapes are substantially rhomboid in shape (rhomboid with rounded corners) are formed in the upper surface of passage unit 4. One acute angled portion of each pressure chamber 10 communicates with each corresponding nozzle 8. The other acute angled portion communicates with sub-manifold passage 5a via an aperture 12. A large number of individual ink passages 7 (see FIG. 5) That communicate with each corresponding nozzle 8 are connected to each sub-manifold passage 5a. Note that in order to make it easier to understand the illustration, FIG. 4 uses solid lines to illustrate pressure chambers 10 (pressure chamber groups 9), apertures 12 and nozzles 8 that are positioned below actuator units 21 in planer view of FIG. 4 and thus should be illustrated with broken lines.

Next, the cross sectional configuration of head main unit 70 will be described. FIG. 5 is a cross section of head main unit 70 at line V-V in FIG. 4, and illustrates one individual ink passage 7. Individual ink passage 7 is a passage for guiding ink in sub-manifold passage 5a to nozzle 8. In the present embodiment, individual ink passage 7 extends upward from sub-manifold passage 5a for a short distance, and then reaches at one end of pressure chamber 10 formed on the upper surface of passage unit 4. Furthermore, individual ink passage 7 extends diagonally downward from the other end of pressure chamber 10 that extends horizontally, and reaches to nozzle 8 formed in the lower surface of passage unit 4. Each of individual ink passages 7 is formed similarly described above. As a whole, each individual ink passage 7 has a bow shape in which pressure chamber 10 is the top portion thereof. This allows a high density arrangement of individual ink passages 7, and achieves smooth flow of ink.

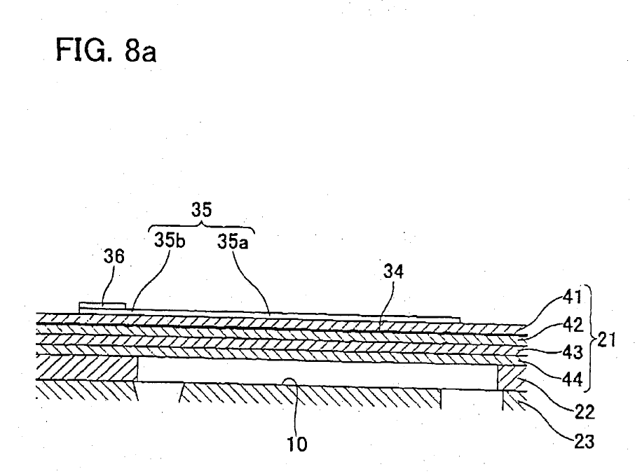

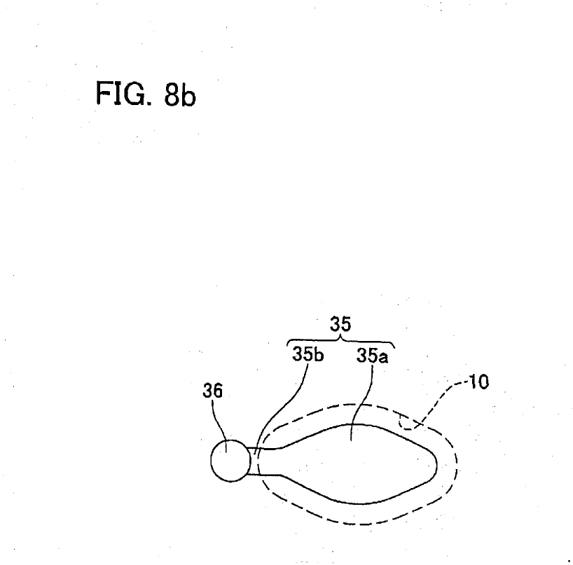

As shown in FIG. 5, head main unit 70 has a laminated structure comprising actuator unit 21 and passage unit 4. Actuator unit 21 is positioned on passage unit 4. Each unit 4, 21 is constructed of a plurality of laminated thin plates. Amongst these, actuator unit 21 has four laminated piezoelectric sheets 41-44 (described in FIG. 8) and has electrodes, as described in detail below. In FIG. 5, actuator unit 21 constructed from four piezoelectric sheets is illustrated as one block in order to simplify the drawing.

Passage unit 4 is constructed of a total of nine laminated sheets, namely cavity plate 22, base plate 23, aperture plate 24, supply plate 25, manifold plates 26-28, cover plate 29, and nozzle plate 30.

Cavity plate 22 is a metal plate having a large number of substantially rhomboid holes that form pressure chambers 10 in a region. Actuator units 21 are attached on the region (i.e., the region forms pressure chamber groups 9).

Base plate 23 is a metal plate having holes that connect each pressure chamber 10 with each corresponding aperture 12 formed in cavity plate 22.

Aperture plate 24 is a metal plate, having holes forming apertures 12. Each aperture 12 corresponds to each pressure chamber 10 formed in cavity plate 22.

Supply plate 25 is a metal plate having holes that connect each apertures 12 formed in aperture plate 24 with each corresponding sub-manifold passage 5a.

Manifold plates 26-28 are metal plates having holes that form sub-manifold passages 5a.

Cover plate 29 is a metal plate having connecting holes 29a. One end of each connecting hole 29a is connected to each corresponding nozzle 8.

Base plate 23, aperture plate 24, supply plate 25 and manifold plates 26-28 have a plurality of other holes respectively, On adjacent plates, each hole of both adjacent plates is connected each other. Respectively connected holes forms an ink flow pass as a whole. Each ink flow pass connects each pressure chambers 10 with the other end of corresponding connecting hole 29a.

Nine plates 22 to 30 are positioned together and laminated, so as to form individual ink passage 7 as shown in FIG. 5. The nine plates that form passage unit 4 are made from same metal material respectively in the present embodiment. More specifically, they are made from SUS 430, but may be made with metal material such as SUS 316 or a 42 alloy. Some or all of plates 22 to 30 may be made with different metal materials.

As is clear from FIG. 5, pressure chamber 10 and aperture 12 are arranged at different levels in the direction in which each plate is laminated. In this way, as shown in FIG. 4, one aperture 12 and one pressure chamber 10 that does not correspond to the one aperture 12 can be arranged at the same position in the laminated direction. As a result, pressure chambers 10 can be arranged at a high density in cavity plate 20. Because the number of nozzles 8 is equal to the number of pressure chambers 10, a high resolution inkjet head with a relatively small ink discharging surface can be achieved by high density arrangement of pressure chambers 10.

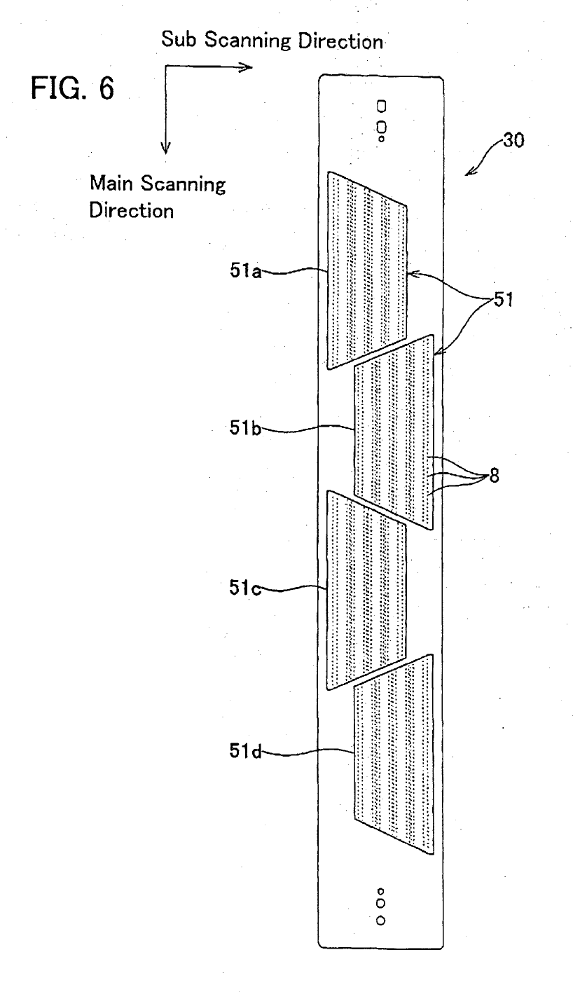

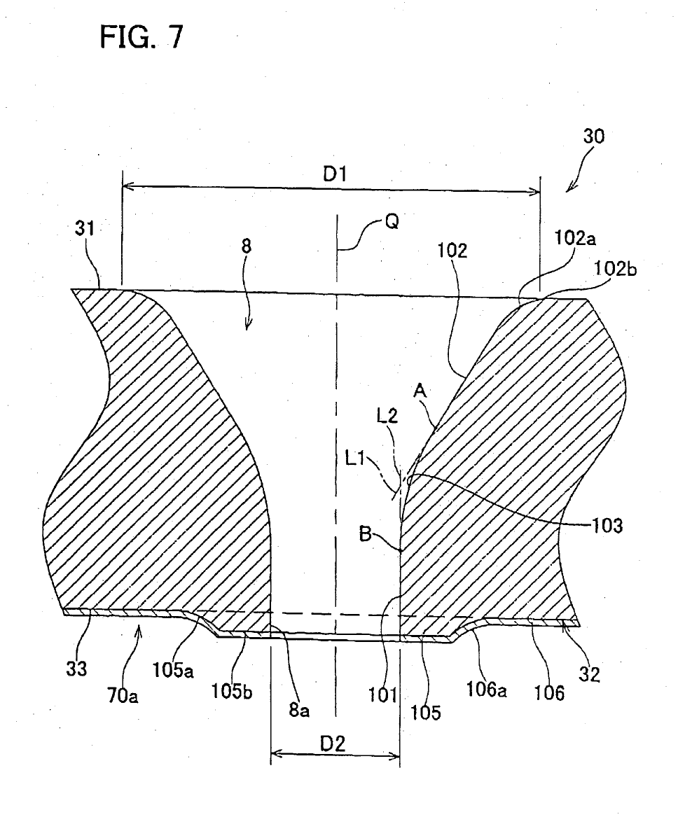

Next, nozzle plate 30 according to the present embodiment will be described. FIG. 6 is a plan view of nozzle plate 30. FIG. 7 shows an enlarged cross section, including nozzle centerline Q, of the area around one nozzle 8 of nozzle plate 30 shown in FIG. 6. As shown in FIG. 6, nozzle plate 30 has a plurality of ink discharging regions 51 in which a plurality of nozzles 8 are arranged. Each ink discharging region 51, corresponds to each actuator unit 21 that is attached to the upper surface of passage unit 4 (see FIG. 3). In the present embodiment, four ink discharging regions 51a to 51d are arranged along the main scanning direction of nozzle plate 30. As noted above, each ink discharging region 51 is arranged so that corresponding actuator unit 21 and corresponding pressure chamber group 9 overlap when viewed in the lamination direction of passage unit 4. Ink discharging regions 51 have substantially the same trapezoid shape as actuator units 21. Four ink discharging regions 51a to 51d have the same arrangement as four actuator units 21 shown in FIG. 3, and the trapezoid shapes are alternately oriented so that the adjacent diagonal lines of adjacent ink discharging regions 51 are parallel with each other. The positions of adjacent ink discharging regions 51 are alternately shifted in the sub scanning direction. In other words, adjacent ink discharging regions 51 are disposed so that the adjacent diagonal edges of the adjacent trapezoids partially overlap in the sub scanning direction of the passage unit 4.

As noted above, a large number of nozzles 8 are formed in nozzle plate 30. The structure of only one nozzle 8 will be described below referring to FIG. 7. The structure of other nozzles 8 is the same.

Outer surface 33 of the nozzle plate is a surface that faces a printing medium (not shown in the drawings) when inkjet head (shown in FIG. 1) is in use. The surface of nozzle plate 30 on the opposite side of outer surface 33 is inner surface 31. Nozzle 8 that penetrate inner surface 31 and outer surface 33 are formed in nozzle plate 30, as shown in FIG. 7. Ink will flow from inner surface side opening 102b of nozzle 8, and be discharged from outer surface side opening 8a. In the present embodiment, diameter D2 of outer surface side opening 8a of the nozzle 8 is approximately 20 μm.

In a cross section that includes centerline Q of nozzle 8, the contour of nozzle 8 has first curved line 102a, first straight line 102, second curved line 103, and second straight line 101. Centerline Q extends in the direction perpendicular to inner surface 31. In other words, centerline Q extends in the penetrating direction of nozzle 8.

First curved line 102a traces a smooth curved line from inner surface 31, and extends toward the inside of the nozzle 8. In other words, inner surface 31 and first curved line 102 are continuous and have no corners.

First straight line 102 extends from first curved line 102 toward outer surface 33 of nozzle plate 30. First straight line 102 extends toward outer surface 33 as it approaches centerline Q of nozzle 8.

Second curved line 103 extends from first straight line 102 toward outer surface 33 of nozzle plate 30. Second curved line 103 extends toward outer surface 33 as it approaches centerline Q of nozzle 8. First straight line 102 and second curved line 103 are connected at point A. Second curved line 103 is tangent to line L1 at point A. Line L1 is the line that extends from first straight line 102. In other words, second curved line 103 and first straight line 102 are smoothly continuous and have no corners therebetween.

Second straight line 101 extends from second curved line 103 toward outer surface 33 of nozzle plate 30. Second straight line 101 is perpendicular to outer surface 33. Second straight line 101 and second curved line 103 are connected at point B. Second curved line 103 is tangent to line L2 at point B. Line L2 is the line that extends from second straight line 101. In other words, second curved line 103 and second straight line 101 are smoothly continuous and have no corners therebetween.

A curved line that links inner surface 31 of the nozzle plate 30 with the connecting point of first curved line 102a of nozzle 8 in the circumferential direction of nozzle 8 forms inner surface side opening 102b of the nozzle 8. A curved line that links outer surface 33 of nozzle plate 30 with the connecting point of second straight line 101 of nozzle 8 in the circumferential direction of nozzle 8 forms outer surface side opening 8a of the nozzle 8. In other words, a contour line of nozzle 8 in a cross section being perpendicular to nozzle centerline Q forms circle. In a cross section that includes centerline Q of nozzle 8, inner surface 31 of nozzle plate 30, first curved line 102a, first straight line 102, second curved line 103, and second straight line 101, are smoothly continuous and have no edges at their boundaries therebetween. Thus, ink that flows from inner surface side opening 102b of nozzle 8 can smoothly flow into nozzle 8. Disruptions to the flow of ink into nozzle 8 can be reduced. In particular, by smoothly linking inner surface 31 with first curved line 102a, disturbances to the flow of ink into the nozzle 8 can be effectively reduced.

Diameter D1 of inner surface side opening 102b of nozzle 8 is larger than diameter D2 of outer surface side opening 8b of nozzle 8. Thus, the flow rate of ink from inner surface side opening 102 will increase, and ink will be discharged from outer surface side opening 8b. The speed at which ink is discharged can be increased. The flow rate of ink flowing into nozzle 8 will increase as ink passes the portions of nozzle 8 corresponding to first curved line 102a, first straight line 102, and second curved line 103, because the inner diameter at those portions gradually becomes smaller. The flow of ink whose speed has been increased will be stable as it passes the portion of nozzle 8 corresponding to second straight line 101, at which the inner diameter of nozzle 8 is fixed at diameter D2 of outer surface side opening 8a of nozzle 8. The ink discharging speed can be increased, stabilized, and then discharged. The printing precision of an inkjet head will improve. An inkjet head that can improve image quality of printed images will be achieved.

Note that the portion of nozzle 8 that corresponds to first straight line 102 will form a tapered hole portion that tapers toward outer surface 33 of nozzle plate 30. The portion of nozzle 8 that corresponds to second curved line 103 will form a curved middle hole portion that tapers toward outer surface 33 of nozzle plate 30. The portion of nozzle 8 that corresponds to second straight line 101 will form a columnar hole portion.

A swelled portion 105 that swells from outer surface 33 of nozzle plate 30 beyond the flat surface of outer surface 33 is formed on outer surface 33 of nozzle plate 30.

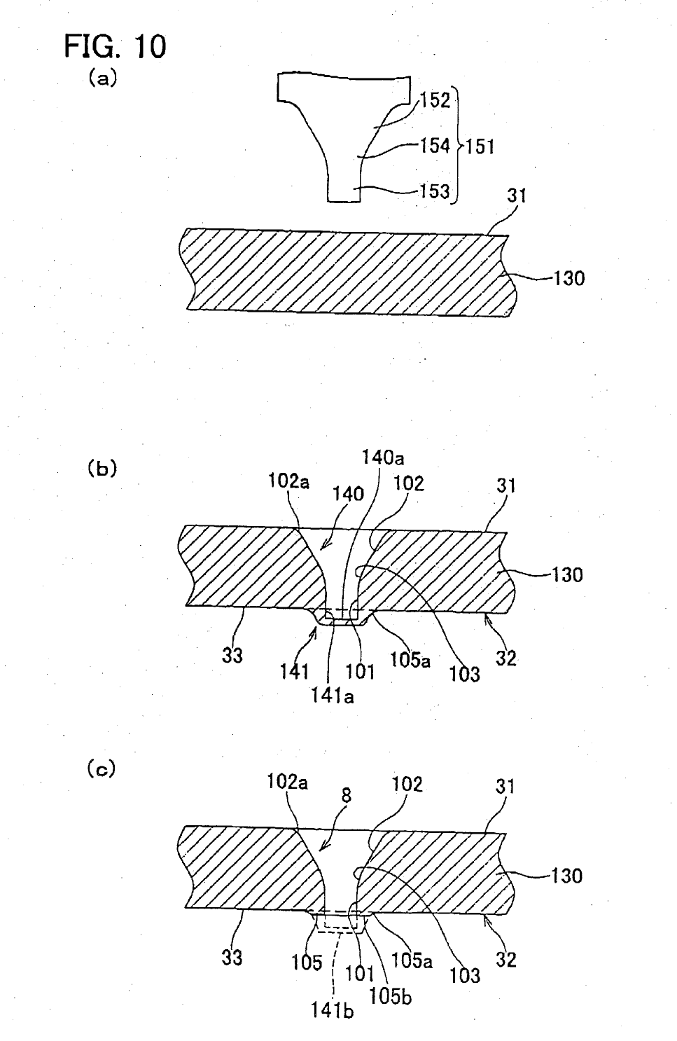

Outer surface side opening 8a of nozzle 8 is positioned within top flat surface 105b of swelled portion 105. As described below in FIG. 10, swelled portion 105 is formed by forming protrusion 141 on outer surface 33 and by removing a top portion on protrusion 141. Protrusion 141 is formed by driving a punch 151 having a predetermined shape into nozzle plate 130 from inner surface 31 side thereof, prior to forming nozzle 8. Therefore protrusion 141 has inner space. By removing the top portion of protrusion 141 (described in FIG. 10) while leaving a foot 105a of protrusion 141, the inner space of protrusion 141 opens within a top flat surface 105b of the foot 105a. The foot 105a corresponds to swelled portion 105. The top flat surface of foot 105a corresponds to top flat surface 105b of swelled portion 105. The opening formed by removing the top portion of protrusion 141 corresponds to outer surface side opening 8a of nozzle 8.

As shown in FIG. 7, top flat surface 105b of swelled portion 105 projects outward more than the flat surface of outer surface 33 of nozzle plate 30. Thus, when the periphery of outer surface side opening 8a of nozzle 8 is to be flattened by means of grinding, only top flat surface 105b of swelled portion 105 needs to be ground. The entire outer surface 33 of nozzle plate 30 need not be ground. Because of that, the periphery of outer surface side opening 8a of nozzle 8 can be flattened in a short period of time. The unnecessary removal of the outer peripheral edge of outer surface side opening 8a of the nozzle 8, caused by warping of a grinding tool, such as a lapping plate, during grinding, or abrasive slurries that flow into the outer surface side opening 8a, can be prevented. Even if the periphery of outer surface side opening 8a of nozzle 8 is flattened, the outer peripheral edge of outer surface side opening 8a can remain sharp.

At a portion around the periphery of top flat surface 105b, swelled portion 105 gradually increases in height from outer surface 33. In other words, at swelled portion 105, a surface of around the periphery of top flat surface 105b will intersect with outer surface 33 in a nearly parallel state. The portion around the periphery of the top flat surface will be referred to as the periphery portion hereinafter.

Water-repellent film 106 is formed on entire surface 32 of nozzle plate 30. Entire surface 32 comprises outer surface 33, top flat surface 105b of swelled portion 105, and the surface of the periphery portion (excluding outer surface side opening 8a of the nozzle 8). Water-repellent film 106 comprises, for example, nickel plating that contains a fluorinated polymer such as polytetrafluoroethylene. The surface of water-repellent film 106 is ink discharging surface 70a. If water-repellent film 106 is not formed on the periphery of outer surface side opening 8a of nozzle 8, ink, dirt, and the like, will easily adhere to the periphery of outer surface side opening 8a. As a result, the discharging direction of the ink discharged from outer surface side opening 8a of nozzle 8 may be disrupted by this adhered material. As in the present embodiment, by forming water-repellent film 106, it will become difficult for ink, dirt, and the like to adhere to the periphery of outer surface side opening 8a of the nozzle 8. The discharging direction of ink discharged from outer surface side opening 5a of the nozzle 8 can be made uniform.

Water-repellent film 106 is formed at substantially the same thickness over entire surface 32 of nozzle plate 30. Water-repellent film 106 also has a curved shape that matches the surface of the portion around the periphery of top flat surface 105b of swelled portion 105. On the surface of the portion around the periphery of top flat surface 105b of swelled portion 105, the height thereof will gradually increase from outer surface 33 toward top flat surface 105b. Portion 106a of water-repellent film 106 corresponding to the surface of the periphery portion will also gradually increase in height. Because of that, when ink or the like that has been adhered on ink discharging surface 70a of nozzle plate 30 is wiped up from one end in the lengthwise direction of nozzle plate 30 to the other end in the lengthwise direction with a wiper or the like (not shown in the drawings), the wiper can smoothly move over ink discharging surface 70a that includes swelled portion 105. When the wiper moves over ink discharging surface 70a that includes swelled portion 105, the wiper will not caught at portion 106a of water-repellent film 106 that covers the periphery portion of swelled portion 105. Because of that, the depletion of the wiper can be reduced, and ink and dirt that has adhered to the periphery of outer surface side opening 8a can be reliably wiped up. Note that even if water-repellent film 106 is not formed on entire surface 32 of nozzle plate 30, because the surface of the periphery portion of swelled portion 105 is shaped to gradually increase in height, the wiper can smoothly move on entire surface 32 including the surface of the periphery portion of swelled portion 105 and top flat surface 105b of swelled portion 105. Because of that, the depletion of the wiper can be reduced, and ink and the like that has adhered to the periphery of outer surface side opening 8a of nozzle 8 can be reliably wiped up, in the same way as noted above.

Next, actuator unit 21 will be described. FIG. 8a is an enlarged cross section of a portion of actuator unit 21 shown in FIG. 5 that is surrounded by the dotted line. FIG. 8b is a plan view of individual electrode 35 that is disposed on actuator unit 21. As shown in FIGS. 8a and 8b, individual electrode 35 is disposed in a position that is opposite to pressure chamber 10. Individual electrode 35 is constructed from primary electrode region 35a that is formed inside the flat surface region of pressure chamber 10 when viewed from the lamination direction of the piezoelectric sheets 41-44, and auxiliary electrode region 35b that is connected to primary electrode region 35a and formed outside the flat surface region of pressure chamber 10.

As shown in FIG. 8a, actuator unit 21 includes four piezoelectric sheets 41-44. Thickness of Each piezoelectric sheets 41-44 is approximately 15 μm. Piezoelectric sheets 41-44 are laminated together to form a single flat plate. The single laminated flat plate is disposed so as to cover plurality of pressure chambers 10 formed inside the ink discharging regions inside the head main unit 70. By creating actuator unit 21 in which piezoelectric sheets 41-44 form the single laminated flat plate that cover plurality of pressure chambers 10, it will be possible for individual electrodes 35 to be disposed at a high density by, for example, employing screen printing technology. Because of that, pressure chambers 10 formed in positions that correspond to individual electrodes 35 can also be disposed at a high density. As a result, an inkjet head that can print high resolution images can be achieved. Piezoelectric sheets 41-44 are made from, for example, a lead zirconate titanate (PZT) type ceramic material having ferroelectricity.

As shown in FIG. 8a, primary electrode region 35a of individual electrode 35 formed on uppermost piezoelectric sheet 41 of actuator unit 21. As shown in FIG. 8b, primary electrode region 35a has a substantially rhomboid shaped flat surface that substantially resembles the shape of pressure chamber 10 in plan view. In other words, the corner portions of the rhomboid are formed to be smoothly curved (e.g., arcuate). The one of the acute angular portions in substantially rhomboid primary electrode region 35a is connected with auxiliary electrode region 35b. Round land 36 that is electrically connected to individual electrode 35 is arranged on the tip of auxiliary electrode 35b. As shown in FIG. 8b, land 36 is disposed in a region in which pressure chamber 10 is not formed in cavity plate 22. Land 36 is made of metal that includes, for example, glass frits. Land 36, as shown in FIG. 8a, is formed on the surface of auxiliary electrode region 35b.

As shown in FIG. 8a, common electrode 34 that is the same shape as piezoelectric sheet 41 and has thickness of approximately 2 μm is interposed between uppermost piezoelectric sheet 41 and piezoelectric sheet 42 laminated below uppermost piezoelectric sheet 41. Individual electrode 35 and common electrode 34 are both made of metal material such as, for example, Ag—Pd or the like.

Common electrode 34 is connected to a ground terminal in region that is not illustrated. Thus, Common electrode 34 maintains a uniform fixed electric potential in the region corresponding to all pressure chambers 10, and in the present embodiment, maintains a ground electric potential.

Next, a method of driving actuator units 21 will be described. Only uppermost piezoelectric sheet 41 of four piezoelectric sheets 41-44 comprises electrodes (individual electrode 35 and common electrode 34) on both surfaces thereof. When electric field is applied between individual electrode 35 and common electrode 34, uppermost piezoelectric sheet 41 will expand or shrink in its thickness direction. Remaining three piezoelectric sheets 42-44 are not comprised of electrodes on both surfaces thereof. Uppermost piezoelectric sheet 41 that will expand or shrink in the thickness direction when electric field is applied will be referred to as the active layer. Remaining three piezoelectric sheets 42-44 that do not comprise electrodes on both surfaces will be referred to as the inactive layers. The polarized direction of piezoelectric sheet 41 in actuator unit 21 is the thickness direction thereof. Actuator unit 21 has a so-called unimorph type construction, in which one piezoelectric sheet 41 on the upper side (in other words, the side furthest from pressure chamber 10) is the active layer, and remaining three piezoelectric sheets 42-44 on the lower side (in other words, the side nearest pressure chamber 10) are the inactive layers. Thus, when individual electrode 35 has a predetermined positive or negative electric potential, the electric field application portion that is sandwiched between the electrodes of piezoelectric sheet 41 will operate as an active portion (pressure generating portion). If, for example, the direction of electric field and the direction of polarized are the same direction, the electric field application portion will shrink in the direction being orthogonal to the polarized direction due to the transversal piezoelectric effect.

In the present embodiment, the portion of piezoelectric sheet 41 sandwiched by individual electrode 35 and common electrode 34 will operate as the active portion that deforms due to the piezoelectric effect when an electric field is applied. On the other hand, remaining three piezoelectric sheets 42-44 laminated below piezoelectric sheet 41 will not be applied an electric field from the exterior. Because of that, three piezoelectric sheets 42-44 will substantially not function as active portion. Thus, the portion of piezoelectric sheet 41 that is sandwiched by primary electrode region 35a and common electrode 34 will shrink in the direction being orthogonal to the polarized direction due to the transversal piezoelectric effect.

On the other hand, piezoelectric sheets 42-44 will not automatically deform because they will not be affected by the electric field. Thus, a difference in deformation in the direction being orthogonal to polarized direction will be generated when a predetermined electric potential is applied to individual electrode 35. At electric field applying region in actuator unit 21, the entirety of laminated four piezoelectric sheets 41-44 will bend so as to protrude toward the non-active layer side (so-called unimorph deformation). At that point, as shown in FIG. 8a, because the lower surface of actuator unit 21 constructed with laminated piezoelectric sheets 41-44 are attached on the upper surface of cavity plate 22. In other words, the lower surface of actuator unit 21 defines the upper wall of pressure chamber 10. Laminated piezoelectric sheet 41-44 (that is equal to actuator unit 21) will, as a result, bend so as to protrude toward pressure chamber 10. Thus, the volume of pressure chamber 10 will lessen, and the pressure of ink inside pressure chamber 10 will rise. As a result, ink will be pushed out from pressure chamber 10 and discharged from the nozzle 8. After that, when individual electrode 35 returns to the same electric potential as the common electrode 34, laminated piezoelectric sheets 41-44 will return to their original shape, and the volume of pressure chamber 10 will return to the original volume. Ink will be drawn into pressure chamber 10 from manifold passage 5.

Note that in another drive method, individual electrode 35 can be given a potential that is different from common electrode 34. In this case, individual electrode 35 will be temporarily given the same potential as common electrode each time there is request for ink discharging from a controller (not shown in the drawings) of the inkjet head. Then, at a predetermined timing, individual electrode 35 will again be given a potential that is different from common electrode 3. In this case, the volume of pressure chamber 10 will be increased when compared to the initial state (the state in which the potential of both electrodes is different), at a timing in which individual electrode 35 and common electrode 34 are the same potential, due to piezoelectric sheets 41-44 returning to their original shape, and ink will be drawn into pressure chamber 10 from manifold passage 5. After that, piezoelectric sheets 41-44 will bend so as to protrude toward pressure chamber 10 at a timing at which individual electrode 35 is again given a potential that is different from the potential at common electrode 34. The pressure on ink in pressure chamber 10 will rise due to the reduction of the volume of pressure chamber 10, and ink will be pushed out from pressure chamber 10. Thus, ink will be discharged from nozzle 8. At the same time, the inkjet head will be moved as appropriate in the main scanning direction to print the desired image on a sheet.

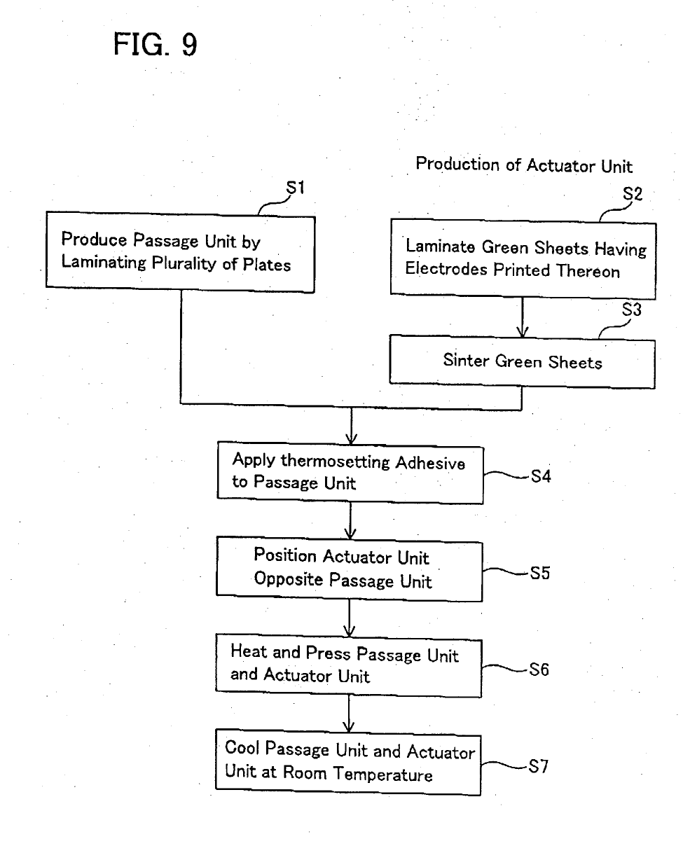

A manufacturing method of inkjet head 1 will be described with reference to FIG. 9. FIG. 9 is a flowchart that shows the manufacturing steps of inkjet head 1.

When manufacturing inkjet head 1, components thereof such as passage unit 4 and actuator units 21 will be produced separately. Then these components will be assembled together. First, in Step S1, passage unit 4 will be produced. When producing passage unit 4, each plate 22-29 that forms passage unit 4, but not the nozzle plate 30, will be subjected to etching with a patterned photo-resist mask, and each hole shown in FIG. 5 will be formed in each plate 22-29. Then, as described below, plurality of nozzles 8 will be formed with punch 151 in a metal plate 130 that will become the nozzle plate 30. Water-repellent film 106 will be formed on entire surface 32 of the metal plate 130 in which the nozzles 8 are formed. Thus, nozzle plate 30 will be formed. Nine plates 22-30 that are positioned together so as to form individual ink passages 7 will be laminated together via an epoxy type thermosetting adhesive. Then, nine plates 22-30 are heated to a temperature that is equal to or greater than the curing temperature of the thermosetting adhesive while applying pressure thereto. In this way, the thermosetting adhesive will be cured, and nine plates 22-30 will be fixed together. Passage unit 4 as shown in FIG. 5 will be obtained. At this point, because each plate 22-33 is formed from the same metal material, the coefficient of linear expansion of each plate 22-30 will be the same, and thus passage unit 4 will not bend in one direction.

On the other hand, when producing actuator units 21, a plurality of green sheets made of piezoelectric ceramic will first be prepared in Step S2. The amount of shrinkage in the green sheets due to pre-sintering will be forecast and then formed. A conductive paste will be screen printed in the pattern of common electrodes 34 on portions of the green sheets. Then, using a jig, the green sheets will be positioned together, and a green sheet on which a conductive paste is printed in the pattern of common electrodes 34 will be stacked below a green sheet on which a conductive paste has not been printed. Below that, two green sheets on which a conductive paste is not printed will be stacked together. The laminated green sheets having electrodes printed thereon is obtained.

Then, in Step S3, the laminated unit obtained in Step S2 will be degreased in the same way as commonly used ceramics, and then further sintered at a predetermined temperature. In this way, four green sheets will become piezoelectric sheets 41-44, and the conductive paste will become common electrodes 34. After that, the conductive paste will be screen printed in the pattern of individual electrodes 35 on piezoelectric sheet 41 that will be the uppermost layer. Then, the conductive paste will be sintered by heating the laminated unit, and individual electrodes 35 will be formed on piezoelectric sheet 41. After sintering, metal that includes glass frits will be printed on individual electrodes 35, and lands 36 will be formed. Thus, actuator unit 21 shown in FIG. 8 can be produced.

Note that because the passage unit production process of Step S1, and the actuator unit production process of Steps S2, S3 are performed separately, either one may be performed before the other, or may be performed simultaneously.

Next, in Step S4, an epoxy type thermosetting adhesive that will cure at about 80° C. will be applied with a bar coater to the surfaces of passage unit 4 obtained in Step S1 in which a large number of recesses that correspond to pressure chambers 10 are formed. A two-part mixture type of thermosetting adhesive may, for example, be employed as the thermosetting adhesive.

Next, in Step S5, actuator units 21 will be mounted on passage unit 4 with a thermosetting adhesive. At this point, each actuator unit 21 will be positioned with respect to passage unit 4 so that the active portions and pressure chambers 10 are facing each other. This positioning will be performed based upon positioning marks (not shown in the drawings) that were formed on passage unit 4 and actuator units 21 in the previous production processes (Steps S1 to Step S3).

Next, in Step S6, the laminated units comprising passage unit 4, the thermosetting adhesive between passage unit 4 and actuator units 21, and actuator units 21 will be heated in a heat/pressure device not shown in the drawings to a temperature equal to or greater than the curing temperature of the thermosetting adhesive while pressure is applied thereto. Then, in Step S7, the laminated unit taken out form the heat/pressure device will be cooled at a room temperature. Thus, head main unit 70 constructed with passage unit 4 and actuator units 21 will be manufactured.

After Step S7, head main unit 70, base block 71, holder 72, driver IC 80, FPC 50 circuit plates 81, and beat sinks 82 (shown in FIG. 1 and 2) are assembled, and inkjet head 1 shown in FIG. 1 will be completed.

Next, the manufacturing method of nozzle plate 30 that forms a portion of aforementioned passage unit 4 will be described. FIG. 10 shows the manufacturing steps of a nozzle plate of the present embodiment. FIG. 10(a) shows a state of metal plate 130 prior to forming nozzles 8. FIG. 10(b) shows a state in which a recessed portion 140 that will later become nozzle 8 formed in metal plate 130. FIG. 10(c) shows a state in which the recessed portion 140 is processed to form a nozzle 8 in metal plate 130.

Metal plate 130 referred to in FIG. 10 is a plate that will become the nozzle plate 30 shown in FIG. 5, 6, and 7. In other words, the metal plate 130 shown in FIG. 10(a) and 10(b) is a nozzle plate prior to nozzle formation, and metal plate 130 shown in FIG. 10(c) corresponds to nozzle plate 30 shown in FIG. 5, 6, and 7.

First, as shown in FIG. 10(a), punch 151 fitted onto a die (not shown in the drawings) will be driven into flat rectangular metal plate 130 from upper surface 31. Metal plate 130 is made from SUS 430. Upper surface 31 corresponds to inner surface 31 of nozzle plate 30. This process is the punch driving step. Punch 151 has, from the tip thereof rearward, cylindrical portion 153, curved portion 154, and tapered shoulder portion 152. Tapered shoulder portion 152 tapers toward the tip of punch 151. Cylindrical portion 153 and curved portion 154 are smoothly curved and continuous in the cross section of punch 151. Curved portion 154 and tapered shoulder portion 152 are smoothly curved and continuous in the cross section of punch 151.

In the punch drive step, the tip of the punch 151 will be driven so as to continue past lower surface 33 of metal plate 130, but not so as to break through lower surface 33. Lower surface 33 corresponds to outer surface 33 of nozzle plate 30. When driven punch 151 is removed, as shown in FIG. 10(b), recessed portion 140 will be formed in upper surface 31 of metal plate 130. First curved line 102a and first straight line 102 shown in FIG. 7 that correspond to tapered shoulder portion 152 of punch 151 will be formed in the contour of the cross section of recessed portion 140. Second curved line 103 shown in FIG. 7 that corresponds to curved portion 154 of punch 151, will also be formed in the recessed portion 140 in the cross section thereof. Second straight line 101 shown in FIG. 7 that corresponds to cylindrical portion 153 of punch 151 will also be formed in the recessed portion 140 in the cross section thereof.

Bottom 140a of recessed portion 140 is positioned below lower surface 32 of metal plate 130. In other words, bottom 140a of recessed portion 140 is positioned beyond lower surface 33 from upper surface 31 of metal plate 130.

On the other hand, bottom 140a of recessed portion 140 covers on lower surface 33 side of metal plate. 130, and protrusion 141 that protrudes downward beyond the flat surface of lower surface 33 is formed. As shown in FIG. 10(b), protrusion 141 has inner space 141a.

The shape of punch 151 will be suitably formed so that a contour line, in the cross section, of recessed portion 140 formed by driving punch 151 into metal plate 130 will match the contour line, in the cross section, of nozzle 8 shown in FIG. 7. When punch 151 is driven into metal plate 130 from upper surface 31 in the punch drive step, the drive speed and drive force of punch 151 will be suitably adjusted so that the contour line, in the cross section, of recessed portion 140 corresponding to the contour line, in the cross section, of nozzle 8 shown in FIG. 7 will not have any edge and will be smoothly continuous except bottom 140a. At the same time, when punch 151 is driven into metal plate 130 in the punch drive step, the shape of punch 151, and the drive speed and drive force thereof, will be suitably adjusted so that the height of protrusion 141 at the surface of the periphery portion will gradually increase from lower surface 33 of metal plate 130.

Next, as shown in FIG. 10(c), top portion 141b of protrusion 141 that includes bottom 140a of recessed portion 140 will be removed with leaving foot 105a of protrusion 141. In other words, top portion 141b of protrusion 141 will be removed until inner space 141a of protrusion 141 is exposed on lower surface side 33 of metal plate 130. Top portion 141b of protrusion 141 will be removed by a mechanical process (e.g., grinding).

By removing top portion 141b of protrusion 141 with bottom 140a of recessed portion 140, recessed portion 140 will become a hole penetrating the metal plate 130. That is to say, recessed portion 140 will become nozzle 8. In other words, by removing top port ion 141b of protrusion 141 until inner space 141a of protrusion 141 is exposed on lower surface 33 side, recessed portion 140 will become nozzle 8. Thus, nozzle 8 will be formed. Foot 105a left while removing top portion 141b corresponds to swelled portion 105 shown in FIG. 7.

The process of removing top portion 141 of protrusion 141 will be performed by means of a lapping and polishing process. In other words, metal plate 130 is set onto a support plate (not shown in the drawings) so that protrusion 141 of metal plate 130 faces the grinding surface of a rotating lapping plate (not shown in the drawings). Slurries including abrasives (i.e., abrasive slurries) will be supplied between metal plate 130 and the grinding surface of the rotating lapping plate in a state in which the support plate and the rotating lapping plate rotate in the same direction. Then, the support plate is moved toward the rotating lapping plate, and metal plate 130 is pressed onto the rotating lapping plate. By this process, protrusion 141 of metal plate 130 will be gradually ground from the top portion of protrusion 141 by means of the abrasive slurries. Top portion 141b of protrusion 141 is ground until inner space 141a of protrusion 141 is exposed on lower surface 33 side of metal plate 130. In other words, bottom 140a of recessed portion 140 will be opened on lower surface 33 side of metal plate 130. By removing, top portion 141b until inner space 141a of protrusion 141 is exposed on lower surface 33, nozzle 8 is formed. The opening of nozzle 8 on lower surface 33 side will be formed within top flat surface 105b of foot 105a. The opening corresponds to outer surface side opening 8a of nozzle 8 shown in FIG. 7.

Note that the support plate in the present embodiment has a diameter that is smaller than the radius of the rotating lapping plate. Then, when protrusion 141 is being ground, the support plate will revolve in the rotating direction of the rotating lapping plate while rotating around its own axis.

By the process of forming protrusion 141 on metal plate 130 and the process of removing top portion 141b of protrusion 141 with leaving foot 105a, the nozzle 8 can be formed in a short period of time. In other words, the time needed for forming nozzle 8 by the lapping and polishing process can be shortened.

In contrast, if entire protrusion 141 is removed without leaving foot 105a in order to form the nozzle 8, substantially the entire lower surface 32 of metal plate 130 will be ground because the abrasive cloth on the rotating lapping plate is pliable. The processing time will be particularly lengthened because of grinding entire lower surface 32. While the entire lower surface 32 of metal plate 130 is being ground, the abrasive cloth will deform, and may enter into the inner space 141a that has begun to open. In additions a large amount of the abrasive slurries may also enter into inner space 141a that has begun to open due to the lengthened processing time. As a result, the periphery of the opening formed on the same level of lower surface 33 may grind overly. The peripheral edge of the opening corresponding to outer surface side opening 8a will be bluntly formed. In addition, because the process will continue while the rotating support plate revolves with respect to the rotating lapping plate, the shape of opening formed on the same level of lower surface 33 may become differently depending on the position of the opening on metal plate 130. The difference depends on such things as the set position of metal plate 130 on the support plate, the radius of the revolutions, the grinding speed, and the like. The difference has specific directionality and/or distribution with regard to the lengthwise direction of metal plate 130 depending on the grinding conditions. As a result, the shape of periphery of each openings formed on the same level of lower surface 33 may form differently. Ink will be discharged from each of openings formed on the same level of lower surface 33. If the shape of periphery of each openings formed on the same level of lower surface 33 may form differently, the discharging direction of ink will be slanted depending on the shape of the opening. High printing precision may not be achieved.

On the other hand, as shown in the present embodiment, by leaving the foot 105a and removing only top portion 141b of protrusion 141, it will no longer be necessary to grind entire lower surface 32 other than top portion 141b of protrusions 141 formed of lower surface 33 of metal plate 130. Thus, the grinding time can be shortened. The unnecessary grinding of the periphery of the opening formed within top flat surface 105b of foot 105a that causes long grinding times can be drastically reduced. In addition, because the periphery of the opening formed within top flat surface 105b of foot 105a will not be unnecessarily ground, the sharp and substantially uniformed shape of the periphery of the openings formed within top flat surface 105b can be achieved. Such openings can discharge ink stably and uniformly. The openings formed within top flat surface 105b correspond to outer surface side opening 8a of nozzle 8 shown in FIG. 7.

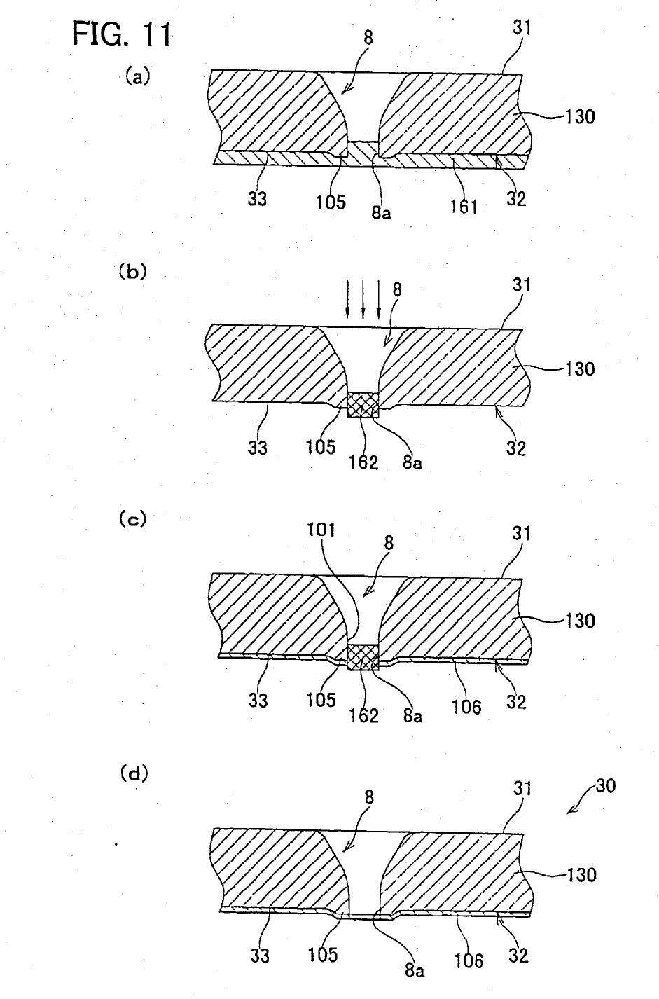

Next, the process of forming water-repellent film 106 on entire lower surface 32 of metal plate 130 in which nozzles 8 are formed will be described below. Metal plate 130 corresponds to nozzle plate 30 shown in FIG. 7. Therefore, metal plate 130 will be referred to as nozzle plate 130 hereinafter. Lower surface 32 will be referred to as outer surface 32 hereinafter. Upper surface 31 will referred to as inner surface 31 hereinafter. FIG. 11 shows the process of forming water-repellent film 106 according to the present embodiment. FIG. 11(a) shows a state in which a photo-curable resin 161 is coated onto the entire surface 32 of nozzle plate 130. FIG. 11(b) shows a state in which a columnar cured resin 162 is formed in the outer surface 32 side portion of the nozzle 8 formed in nozzle plate 130. FIG. 11(c) shows a state in which water-repellent film 106 is formed on outer surface 33 of nozzle plate 130. FIG. 11(d) shows a state in which columnar cured resin 162 is removed.

When water-repellent film 106 is to be formed on entire surface 32 of nozzle plate 130, first, as shown in FIG. 11(a), a film of photo-curable resin 161 that acts as a resist will be heated while pressing the resin onto entire surface 32 of nozzle plate 130 by a roller or the like. In this process, the heating temperature, the pressure, the roller speed, and the like will be adjusted, and a predetermined amount of the photo-curable resin 161 will be filled into outer surface side portion of nozzle 8. This process is a step for coating photo-curable resin 161 on outer surface 33. Here, in the case where the heating temperature is too high when pressing the film, e.g., when the heating temperature is too high than the glass transition point, photo-curable resin 161 will exhibit fluidity, and photo-curable resin 161 can no longer be coated on entire surface 32 at a desired thickness. In contrast, in the case where the heating temperature is too low, photo-curable resin 161 will not soften, and the amount of photo-curable resin 161 needed to fill outer surface side portion of nozzle 8 may not be obtained. Accordingly, in the present embodiment, the heating temperature will be set to a range of 80° C. to 100° C. This temperature range is the temperature range of the glass transition state at which photo-curable resin 161 will exhibit pliable rubber-like qualities. In order to make it easy to fill outer surface side portion of nozzle 8 with certain amount of photo-curable resin 161 needed to form columnar cured resin 162, the thickness of the film of photo-curable resin 161 is no more than the diameter (shown by symbol D2 in FIG. 7) of outer surface side opening 8a of nozzle 8.

Next, as shown in FIG. 11(b), ultraviolet light, laser light, or the like will be radiated onto photo-curable resin 161 from inner surface 31 side through nozzle 8. Only photo-curable resin 161 filled in the outer surface 33 side portion of nozzle 8 will be cured. This process is a step of radiating light. Here, by adjusting the amount of light exposure and curing photo-curable resin 161 only in the direction that nozzle 8 extends in order to form columnar cured resin 162 that projects partially out from the outer surface 33 of nozzle plate 130, and to form columnar cured resin 162 that has a diameter equal to the diameter of outer surface side opening 8a of nozzle 8. At this point, as in the conventional technology, when outer surface 33 of nozzle plate 130 is ground in order to form the outer surface side opening 8a at the same level of outer surface 33, the peripheral edge of the outer surface side opening 8a will become brunt. If the peripheral edge of opening 8a becomes brunt, the radiated light will be irregularly reflected near the bluntly shaped periphery of opening 8a. Light will no longer be uniformly radiated on photo-curable resin 161 at the periphery of opening 8a. As a result, a columnar cured resin having columnar surfaces that are irregularly shaped may be formed. However, in the present embodiment, because the outer peripheral edge of outer surface side opening 8a is formed to be sharp, columnar cured resin 162 having a diameter substantially equal to the diameter of outer surface side opening 8a and smooth columnar surface can be formed. Even if the outer periphery of the outer surface side opening 8a is ground, the amount of grinding will be small, and will be substantially uniform on the top flat surface of the swelled portion 105. Thus, the shape and the size of columnar cured resin 162 will be substantially the same as the shape and size of outer surface side opening 8a of nozzle 8. Furthermore, columnar cured resin 162 will extend outward from outer surface side opening 8a with maintaining substantially the same size and shape.

Then, as shown as FIG. 11(b), the uncured portions of photo-curable resin 161 on the entire surface 32 of nozzle plate 130, other than columnar cured resin 162, will be dissolved and removed by means of a developing solution. Columnar cured resin 162 will be left in a state in which it extend outward from outer surface side opening 8a. This process is a step of removing the uncured photo-curable resin. At this point, one end of columnar cured resin 162 will remain in a state which closed outer surface side opening 8a of nozzle 8. As shown in FIG. 11(c), in this state, a water-repellent plating such as a nickel plating or the like containing a fluorinated polymer such as polytetrafluoroethylene will be formed on the entire surface 32 of nozzle plate 130, and water-repellent film 106 possessing a substantially uniform thickness will be formed. This process is a step of forming a water-repellent film. Then, as shown in FIG. 11(d), columnar cured resin 162 will be dissolved and removed by means of a stripper after the formation of water-repellent film 106. This process is a step of removing the columnar cured resin. Thus, nozzle plate 130 on which water-repellent film 106 is formed will be manufactured.

Here, columnar cured resin 162 partially extend outward from the entire surface 32 of nozzle plate 130, and is formed with a diameter that is equal to the diameter of outer surface side opening 8a of nozzle 8. Thus, when columnar cured resin 162 formed in outer surface 33 side portion of nozzle 8 is removed after forming water-repellant film 106, an opening will be formed in water-repellent film 106 in the position of nozzle 8 that has the same shape as outer surface side opening 8a of nozzle 8. In other words, water-repellent film 106 will be formed along the outer periphery of outer surface side opening 8a of nozzle 8. Furthermore, columnar cured resin 162 will extends outward from outer surface side opening 8a with maintaining substantially the same size and shape of outer surface side opening 8a of nozzle 8. Thus, the shape and size of the opening formed in water-repellent film 106 is constant in the thickness direction. Because of that, the water repellency near the outer periphery of outer surface side opening 8a of nozzle 8 that discharges ink will improve, and ink wetting can be reliably prevented. In addition, the shape of the opening formed in water-repellent film 106 is constant in the film thickness direction. Therefore, ink that is discharged from outer surface side opening 8a of nozzle 8 will no longer strike water-repellent film 106. As a result, ink discharging direction will be stable, and the quality of the image printed on a printing medium can be improved.

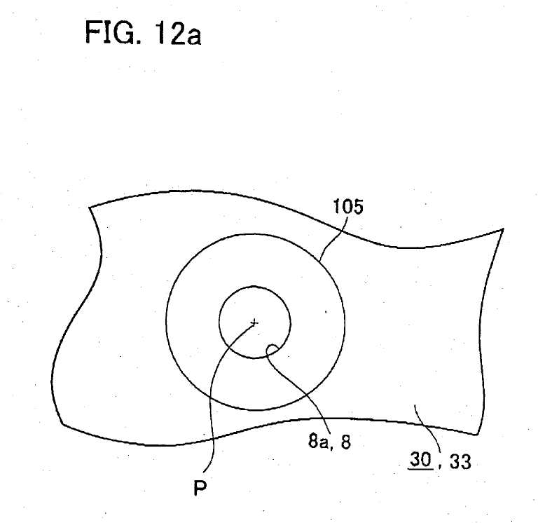

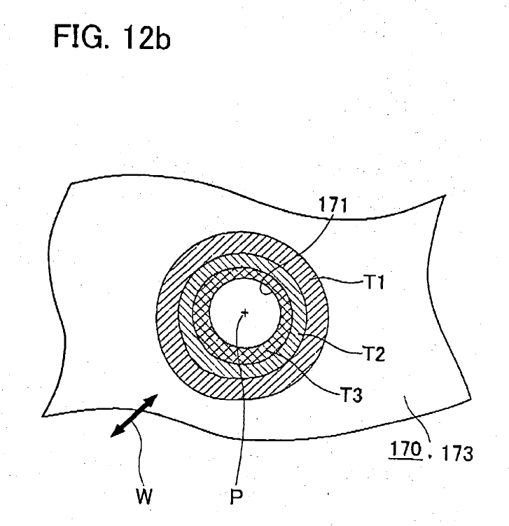

Next, nozzle plate 30 on which swelled portion 105 is formed according to the present embodiment, and nozzle plate 170 according to the conventional technology which does not have a swelled portion formed thereon, will be comparatively described. FIG. 12a is a partial enlarged plan view showing the area around outer surface side opening 8a of nozzle 8 according to the present embodiment. FIG. 12b is a partial enlarged plan view showing the area around outer surface side opening 171 of a nozzle according to the conventional technology. Note that in FIGS. 12a and 12b, illustration of the water-repellent film is omitted in order to make the drawings easier to understand. Outer surface side opening 8a of nozzle 8 shown in FIG. 12a is formed within swelled portion 105 formed on outer surface 33 of nozzle plate 30. Outer surface side opening 8a is formed a substantially circular shape around point P. Outer surface side opening 171 of the nozzle shown in FIG. 12b is formed on outer surface 173 of nozzle plate 170 on which a swelled portion is not formed. Outer surface side opening 171 is formed a substantially circular shape around point P. However, in the area around outer surface side opening 171 shown in FIG. 12b, when outer surface 173 of nozzle plate 170 is used as a height level reference, there are three regions T1-T3 formed that have different height levels. Region T1 is −0.2 μm with respect to the height level of outer surface 173. Region T2 is −0.4 μm with respect to the height level of outer surface 173. Region T3 is −0.8 μm with respect to the height level of outer surface 173. In other words, regions are formed on the periphery of outer surface side opening 171 that have levels which gradually become lower near outer surface side opening 171. In addition, although the shapes of the regions T1-T3 are substantially circular, the center of each region T1-T3 is formed in a position that is slightly shifted diagonally downward and left in FIG. 12b from the center (point P) of outer surface side opening 171. Overall, the low level regions are shifted in the diagonal direction (the direction shown with arrow W in FIG. 12b). When ink is discharged from this type of outer surface side opening 171, the tails, i.e., the rear ends, of the ink drops will shift-toward the most narrow portion of three regions T1-T3, i.e., diagonally to the right and on the upper side of outer surface side opening 171 in FIG. 12b. In the cross section of nozzle plate 170 that includes center P of outer surface side opening 171, large and small differences in the distance from the tails of the ink drops will be produced with the narrow portion and the large portion of the intervals of three regions T1-T3, and the tails of the ink drops will be dragged to side in which the distance is small. Because of that, the direction in which ink is discharged will not be in the direction that is desired. Furthermore, because the shapes of three regions T1-T3 are different due to the nozzle position inside the nozzle plate 170, the direction in which ink is discharged from each nozzle will differ for each nozzle. In contrast, as shown in FIG. 12a, regions that correspond to regions T1-T3 shown in FIG. 12b are not formed in the periphery of outer surface side opening 8a. Thus, by forming swelled portion 105, regions in which the levels gradually become lower from outer surface 33 of nozzle plate 30 toward the periphery of outer surface side opening 8a can be prevented from being formed. This is because when outer surface side opening 8a is to be formed, outer surface 33 of nozzle plate 30 will not be ground by means of abrasive slurries. Or, as described in FIG. 10, it is because the portion that will be ground in order to form outer surface side opening 8a is only top portion 141b of protrusion 141, and thus the time needed to form outer surface side opening 8a of nozzle 8 in metal plate 130 that will become the nozzle plate 30 can be shortened. Because the time needed to form outer surface side opening 8a will be short, the time needed to contact the surface of the lapping plate with top flat surface 105b of swelled portion 105 (see FIG. 7) will be shortened, and the amount of top flat surface 105b of swelled portion 105 that will be ground will be reduced. Note that as shown by T1-T3 in FIG. 12b, a shape in which the level of outer surface 173 of nozzle plate 170 gradually lowers from the flat surface thereof toward outer surface side opening 171 will be produced in a narrow area around the outer periphery of outer surface side opening 171. This means that the gradually lowering of the level of the outer surface 173 of nozzle plate 170 from the flat surface thereof toward outer surface side opening 171 will form a blunt outer peripheral edge on outer surface side opening 171.

According to the inkjet head of the present embodiment, when ink is discharged from outer surface side opening 8a of nozzle 8, the ink drops will be straight from the tips to the rear ends thereof, and the tails will not be curved. Because of that, the ink discharging direction for each nozzle 8 will be stable and uniformed. Therefore, deterioration in image quality that is caused by deviations in the ink discharging direction can be prevented.

As shown in FIG. 10, with the manufacturing method of the inkjet head of the present embodiment, protrusions 141 on outer surface 33 that are formed with punch 151 will not be completely removed. The foot 105a having the inner space 141a will be leaved, and top portion 141b of protrusion 141 will be removed until inner space 141a is exposed on outer surface 33. By doing so, as shown in FIG. 12b, a region will not be formed in which the level will gradually lower from the level of the outer surface 173 toward the outer periphery of outer surface side opening 171. Nozzle plate 30 can be formed to have a sharp edge on the outer periphery of outer surface side opening 8a of nozzle 8.

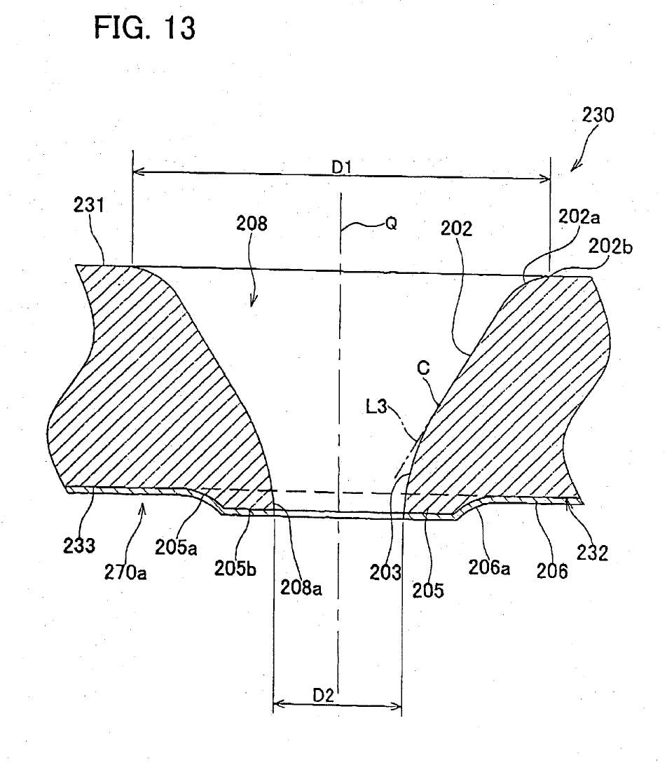

Note that when a plurality of protrusions on a long metal plate are to be completely removed with the lapping and polishing process without leaving foot, the following shortcomings will be produced. Because the relative rotational speeds of the metal plate and the rotating lapping plate differ on both ends and the middle of the metal plate in the lengthwise direction, deviations in the shape of the low level regions around the outer surface side opening of the nozzle will be produced due to the position of the outer surface side openings on the metal plate. In other words, due to the position of the nozzles on the nozzle plate, the shapes of the outer peripheral edges of the outer surface side openings will differ. When this occurs, deviation in the ink discharging direction of each nozzle will be produced. High quality image printing can no longer be expected. However, in the present embodiment, the time needed for grinding will be shortened because only top portions 141b of protrusions 141 formed by punch 151 will be ground in order to form swelled portion 105. Because of that, even if a difference in rotational speed is produced, a large amount of abrasive slurries can be inhibited from entering into nozzle 8 and grinding the periphery of outer surface side opening 8a. The shape of the periphery of outer surface side openings 8a of nozzles 8 distributed on nozzle plate 30 can be uniformly formed.

<Second embodiment> A second embodiment of the present invention will be described below. FIG. 13 is a partial enlarged cross section in the area around nozzle 208 of nozzle plate 230 according to the second embodiment of the present invention. As shown in FIG. 13, nozzle 208 that penetrate inner surface 231 and outer surface 233 are formed in nozzle plate 230. The contour of nozzle 208 in a cross section that includes centerline Q of nozzle 208 has first curved line 202a that is identical with first curved line 102a of nozzle 8 shown in FIG. 7. In addition, nozzle 208 has straight line 202 that is identical with first straight line 102 of the nozzle 8 shown in FIG. 7. Furthermore, the contour of nozzle 208 in a cross section that includes centerline Q of nozzle 208 has second curved line 203.

First curved line 202a traces a smooth curved line from inner surface 231 of nozzle plate 230, and extends toward the inside of nozzle 208. In other words, inner surface 231 and first curved line 202a of nozzle plate 230 are continuous and have no corners therebetween.

Straight line 202 extends from first curved line 202a toward outer surface 233 of nozzle plate 230. Straight line 202 extends toward outer surface 233 as it approaches centerline Q of nozzle 208.

Second curved line 203 extends from straight line 202 toward outer surface 233 of nozzle plate 230. Second curved line 203 extends toward outer surface 233 as it approaches centerline Q of nozzle 208. Straight line 202 and second curved line 203 are connected at point C. Second curved line 203 is tangent to straight line L3 at point C. Straight line L3 extends from straight line 202. In other words, second curved line 203 and straight line 202 are smoothly continuous and have no corners therebetween.

A curved line that links inner surface 231 of nozzle plate 230 with the connecting point of first curved line 202a of nozzle 208 in the circumferential direction of nozzle 208 forms inner surface side opening 202b of nozzle 208. A curved line that links outer surface 233 of nozzle plate 230 with the connecting point of second curved line 203 of nozzle 208 in the circumferential direction of nozzle 208 forms outer surface side opening 208a of nozzle 208. In a cross section that includes centerline Q of nozzle 208, inner surface 231 of nozzle plate 230, first curved line 202a, straight line 202, and second curved line 203, are smoothly continuous and have no corners. The inner diameter of nozzle 208 does not abruptly change from inner surface side opening 202b of nozzle 208 toward outer surface side opening 208a. Thus, ink that flows from inner surface side opening 202b of nozzle 208 can smoothly flow into nozzle 208. Disruptions to the flow of ink into nozzle 208 can be reduced.

Diameter D1 of inner surface side opening 202b of nozzle 208 is larger than diameter D2 of outer surface side opening 208b of nozzle 208. Thus, the flow rate of ink from inner surface side opening 202 will increase, and ink will be discharged from outer surface side opening 208b. The speed at which ink is discharged can be increased. The flow rate of ink into nozzle 208 will increase at each nozzle portion corresponding to first curved line 202a, straight line 202, and second curved line 203, in which the inner diameter of nozzle 208 gradually becomes smaller. The discharging speed of ink will increase. The printing precision of the inkjet head will improve.

Note that the portion of the nozzle 208 that corresponds to straight line 202 will form a tapered bole portion that tapers toward outer surface 233 of nozzle plate 230. The portion of the nozzle 208 that corresponds to second curved line 203 will form a curved hole portion that tapered toward outer surface 233 of nozzle plate 230.

A swelled portion 205 that swells outward from outer surface 233 will be formed on outer surface 233 of nozzle plate 230. Outer surface side opening 208a of nozzle 208 is positioned within top flat surface 205b of swelled portion 205. The height of the periphery portion of swelled portion 205 will gradually increase in the periphery of swelled portion 205 from outer surface 233 of nozzle plate 203 to top flat surface 205b.

Water-repellent film 206 that is identical to aforementioned water-repellent film 106 is formed on entire surface 232 comprising outer surface 233, the surface of the periphery portion of swelled portion 205, and top flat surface 205b of swelled portion 205 (and excepting for outer surface side opening 208a of nozzle 208). The surface of water-repellent film 206 forms ink discharging surface 270a. In addition, water-repellent film 206 is formed with a thickness that is substantially the same in the formation region, and has surface 206a along the surface of the periphery portion of swelled portion 205. Like in the first embodiment, ink, dirt, and the like will rarely adhere to ink discharging surface 270a. The discharging direction of ink discharged from outer surface side opening 208a of nozzle 208 can be made uniform. Because of that, the depletion of the wiper can be reduced, and ink and the like that has adhered to the periphery of outer surface side opening 208a of nozzle 208 can be reliably wiped up, in the same way as in the first embodiment.

The manufacturing method of nozzle plate 230 can be substantially identical to that of the first embodiment. In other words, a die that is comprised of a punch in which a portion corresponding to cylindrical portion 153 of punch 151 shown in FIG. 10(a) is not formed will be driven into a metal plate that will become the nozzle plate 230. Nozzle plate 230 can be manufactured in the same way as the manufacturing method shown in the first embodiment. Note that when manufacturing nozzle plate 230, a punch having cylindrical portion 153 may be employed. In this case, before the top portion of a protrusion is to be removed, the punch will be driven into the metal plate so as to also remove the cylindrical hole portion formed to correspond to cylindrical portion 153. When FIG. 7 is used to describe this, the punch will be driven so that connection point B between second straight line 101 and second curved line 103 in FIG. 7 will be positioned more outward than outer surface 33 of nozzle plate 30. However, the punch must be driven so as not to break through outer surface 33 of nozzle plate 30.

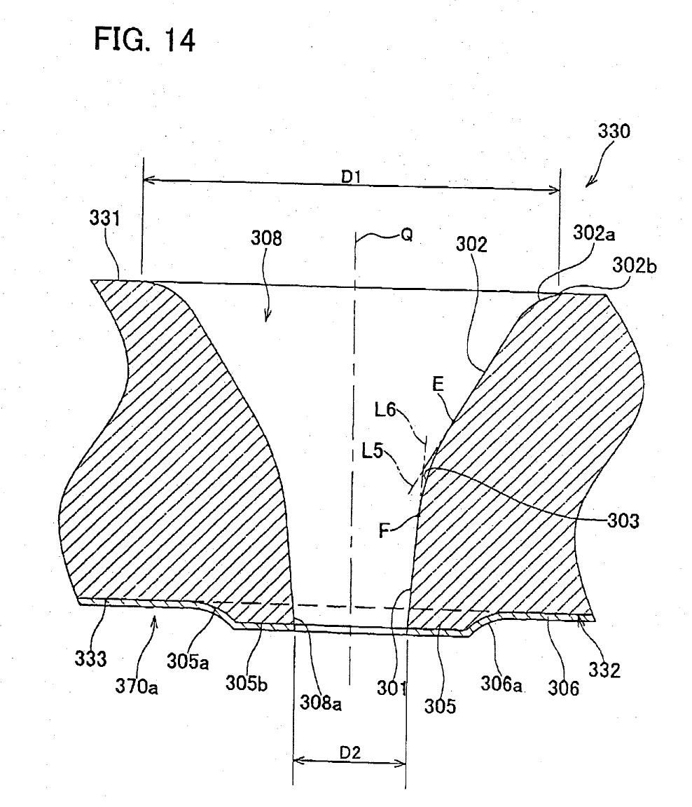

As noted above, even with nozzle plate 230 according to the second embodiment, swelled portion 205 will be formed near the tip of nozzle 208 like in the first embodiment. The grinding time for outer surface 233 of nozzle plate 230 can be shortened. The peripheral edge of outer surface side nozzle opening 208a of nozzle 208 can be made sharp. Because of that, when ink is discharged from outer surface side opening 208a, the ink drops will be straight from the tips to the rear ends thereof, and the tails thereof will not be curved. Therefore, the ink discharging direction of each nozzle 208 will be stable and uniformed. The print quality can be improved. In addition, nozzle 208 is formed so that straight line 202 and second curved line 203 are smoothly continuous in a cross section that includes centerline Q of nozzle 208. The inner diameter of nozzle 208 will gradually decrease from inner surface 231 of nozzle plate 230 toward outer surface 233. Ink can flow smoothly inside nozzle 208. The ink discharging direction can be made more stable.

<Third embodiment> A third embodiment of the present invention will be described below. FIG. 14 is a partial enlarged cross section of nozzle plate 330 according to the third embodiment of the present invention. As shown in FIG. 14, nozzle plate 330 has nozzles 308 that penetrate inner surface 331 and outer surface 333 therebetween.

The contour of nozzle 308 in a cross section that includes centerline Q of nozzle 308 has first curved line 302a that is identical with first curved line 102a of nozzle 8 shown in FIG. 7. The nozzle 308 has first straight line 302 that is identical with first straight line 102 of nozzle 8 shown in FIG. 7. Nozzle 308 has second curved line 303 that is identical with second curved line 103 of nozzle 8 shown in FIG. 7. In addition, the contour of nozzle 208 in a cross section that includes the centerline Q of nozzle 208 has second straight line 301.

First curved line 302a traces a smooth curved line from inner surface 331 of nozzle plate 330, and extends toward the inside of nozzle 308. In other words, inner surface 331 and first curved line 302a of nozzle plate 330 are continuous and have, no edges.

First straight line 302 extends from first curved line 302a toward outer surface 333 of nozzle plate 330. First straight line 302 extends toward outer surface 333 as it approaches centerline Q of nozzle 308.

Second curved line 303 extends from first straight line 302 toward outer surface 333 of nozzle plate 330. Second curved line 303 extends toward outer surface 333 as it approaches centerline Q of nozzle 308. First straight line 302 and second curved line 303 are linked at point E. Second curved line 303 is tangent to straight line L5 at point E. Straight line L5 extends from first straight line 302. In other words, second curved line 303 and first straight line 302 are smoothly continuous and have no corners.

Second straight line 301 extends from second curved line 303 toward outer surface 333 of nozzle plate 330. Second straight line 301 extends toward outer surface 333 as it approaches centerline Q of nozzle 308. Second straight line 301 and second curved line 303 are linked at point F. Second curved line 303 is tangent to straight line L6 at point F. Straight line L6 extends from second straight line 301. In other words, second curved line 303 and second straight line 301 are smoothly continuous and have no corners.

A curved line that links inner surface 331 of nozzle plate 330 with the connecting point of first curved line 302a of nozzle 308 in the circumferential direction of nozzle 308 forms inner surface side opening 302b of nozzle 308. A curved line that links outer surface 333 of nozzle plate 330 with the connecting point of second straight line 301 of nozzle 308 in the circumferential direction of nozzle 308 forms outer surface side opening 308a of nozzle 308. In a cross section that includes centerline Q of nozzle 308, inner surface 331 of nozzle plate 330, first curved line 302a, first straight line 302, second curved line 303, and second straight line 301, are smoothly continuous and have no corners. The inner diameter of nozzle 308 does not abruptly change from inner surface side opening 302b of nozzle 308 toward outer surface side opening 308a. Thus, ink that flows from inner surface side opening 302b of nozzle 308 can smoothly flow into nozzle 308. Disruptions to the flow of ink into nozzle 308 can be reduced.

Diameter D1 of inner surface side opening 302b of nozzle 308 is larger than Diameter D2 of outer surface side opening 308b of nozzle 308. Thus, the flow rate of ink from inner surface side opening 302 will increase, and ink will be discharged from outer surface side opening 308b. The speed at which ink is discharged can be increased. The flow rate of ink in nozzle 308 will increase between a portion of nozzle 308 corresponding to first curved line 302a, first straight line 302, and second curved line 303 respectively, in which the inner diameter of nozzle 308 gradually becomes smaller. The discharging speed will increase at those portions of nozzle 308. The printing precision of the inkjet head will improve. In particular, in the third embodiment, the diameter of nozzle 308 from inner surface side opening 302b to outer surface side opening 308a will gradually become smaller. The flow rate of ink flowing from inner surface side opening 302b can be further increased.

Note that the portion of the nozzle 308 that corresponds to first straight line 302 will form a tapered hole portion that tapers toward outer surface 333 of nozzle plate 330. The portion of the nozzle 308 that corresponds to second curved line 303 will forms a curved middle hole portion that tapered toward outer surface 333 of nozzle plate 330. The curved middle hole portion traces a curved line 303 in a cross section that includes centerline Q of nozzle 308. Note that the portion of the nozzle 308 that corresponds to the second straight line 301 will form a second tapered hole portion that tapers toward outer surface 333 of nozzle plate 330.

Swelled portion 305 that swells outward from outer surface 333 will be formed on outer surface 333 of nozzle plate 330. The top of swelled portion 305 forms top flat surface 305b. Outer surface side opening 308a of nozzle 308 is positioned within top flat surface 305b of swelled portion 305. The height of the periphery portion of swelled portion 305 will gradually increase from outer surface 333 to top flat surface 305b. Swelled portion 305 will be formed in the same way as swelled portion 105 of the first embodiment. Thus, swelled portion 305 has the same effects as the first embodiment.

Water-repellent film 306 that is identical to aforementioned water-repellent film 106 is formed on entire surface 332 of nozzle plate 330. Entire surface 332 comprises outer surface 333, the surface of the periphery portion of swelled portion 305, and top flat surface 305b of swelled portion 305 (and excepting for outer surface side opening 308a of nozzle 308), and the surface of water-repellent film 306 forms ink discharging surface 370a. Water-repellent film 306 is formed in the same way as in the first embodiment. Thus, water-repellent film 306 has the same effects as the first embodiment.

The manufacturing method of nozzle plate 330 can be substantially identical to that of the first embodiment. In other words, the portion corresponding to the cylindrical portion 153 of punch 151 shown in FIG. 10(a) may form a tapered shape that tapers toward the tip. By employing this type of punch in the same method as that of the first embodiment, nozzle plate 330 can be manufactured.

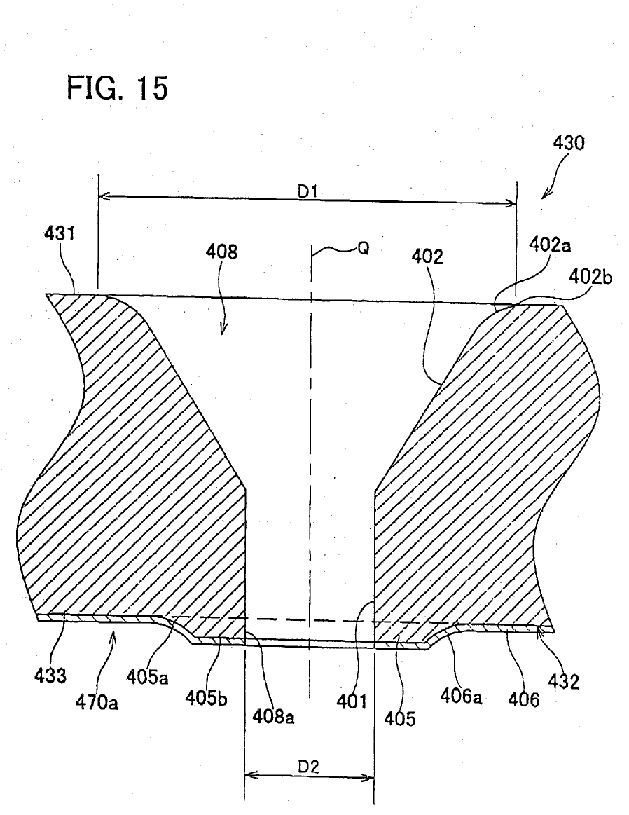

As noted above, even with nozzle plate 330 according to the third embodiment, outer surface side opening 308a of nozzle 308 will be disposed within top flat surface 305b of swelled portion 305 like in the first embodiment. The grinding time needed to remove the top portions of the protrusions formed on nozzle plate 330 can be shortened. The outer peripheral edge of outer surface side opening 308a of nozzle 303 will be formed to be sharp, even when grinding is performed. Because of that, when ink is discharged from outer surface side opening 308a, the ink drops will be straight from the tips to the rear ends thereof, and the tails thereof will not be curved. The ink discharging direction of each nozzle 308 will be stable and uniformed. An inkjet head having improved print quality can be achieved.

<Fourth embodiment> A fourth embodiment of the present invention will be described below. FIG. 15 is a partial enlarged cross section of nozzle plate 430 according to the fourth embodiment of the present invention. As shown in FIG. 15, nozzles 408 that penetrate inner surface 431 and outer surface 433 therebetween are formed in nozzle plate 430. The contour of nozzle 408 in a cross section that includes centerline Q of nozzle 408 has first curved line 402a that is identical with first curved line 102a of nozzle 8 shown in FIG. 7. In addition, nozzle 408 has first straight line 402 that is identical with first straight line 102 of nozzle 8 shown in FIG. 7. Nozzle 408 has second straight line 401 that is identical with second straight line 101 of nozzle 8 shown in FIG. 7.

The first curved line 202a traces a smooth curved line from inner surface 431 of nozzle plate 430, and extends toward the inside of nozzle 408. In other words, inner surface 431 and first curved line 402 of nozzle plate 430 are continuous and have no corners.

First straight line 402 extends from first curved line 402 toward outer surface 433 of nozzle plate 430. First straight line 402 extends toward outer surface 433 as it approaches centerline Q of nozzle 408.

Second straight line 401 extends from first straight line 402 toward outer surface 433 of nozzle plate 430. Second straight line 401 is perpendicular to outer surface 433 of nozzle plate 430.

A curved line that links inner surface 431 of nozzle plate 430 with the connecting point of first curved line 402a of nozzle 408 in the circumferential direction of the nozzle 408 forms inner surface side opening 402b of nozzle 408. A curved line that links outer surface 433 of nozzle plate 430 with the connecting point of second straight line 401 of nozzle 408 in the circumferential direction of nozzle 408 forms outer surface side opening 408a of nozzle 408. In a cross section that includes centerline Q of nozzle 408, inner surface 431 of nozzle plate 430, first curved line 202a, and first straight line 402, are smoothly continuous and have no corners. The diameter of the nozzle 408 in the portion of nozzle 408 corresponding to curved line 402a and first straight line 402 gradually becomes smaller from inner surface side opening 402b of the nozzle 408 to the outer surface side end of first straight line 402. The flow rate of ink flowing into nozzle 408 from inner surface side opening 402b can be further increased due to those portions of nozzle 408. The diameter of nozzle 408 is fixed in the portion of nozzle 408 that corresponds to second straight line 401. The flow of the high speed ink will be stabilized due to this portion. The flow rate can be increased and stabilized when ink is discharged. The printing precision of the inkjet head will improve.

As shown in FIG. 15, in the fourth embodiment, the contour of nozzle 408 in the cross section including centerline Q of nozzle 408 will be simple. Because the contour of the cross section is simple, nozzle 408 will be easy to form.

Note that the portion of nozzle 408 that corresponds to the first straight line 402 will form a tapered hole portion that tapers toward outer surface 433 of nozzle plate 430. The portion of nozzle 408 that corresponds to second straight line 401 will form a columnar hole portion.

Swelled portion 405 that swells outward from outer surface 433 will be formed on outer surface 433 of nozzle plate 430. The top portion of swelled portion 405 forms top flat surface 405b. Outer surface side opening 408a of nozzle 408 is positioned within top flat surface 405b of swelled portion 405. The height of the periphery portion of swelled portion 405 will gradually increase from outer surface 433 to top flat surface 405b. Swelled portion 405 will be formed in the same way as swelled portion 105 of the first embodiment. Thus, swelled portion 405 has the same effects as the first embodiment.

Water-repellent film 406 that is identical to aforementioned water-repellent film 106 shown in FIG. 7 is formed on entire surface 432 of nozzle plate 430. Entire surface 432 comprises outer surface 433, the surface of periphery portion of swelled portion 405, and top flat surface 405b of swelled portion 405 (and excepting for outer surface side opening 408a). The surface of water-repellent film 406 forms ink discharging surface 470a. Water-repellent film 406 is formed in the same way as in the first embodiment. Thus, water-repellent film 406 has the same effects as the first embodiment.

The manufacturing method of nozzle plate 430 can be substantially identical to that of the first embodiment. In other words, without forming a portion that corresponds to curved portion 154 of punch 151 shown in FIG. 10(a), a punch will be prepared that is shaped so that cylindrical portion 153 and tapered shoulder 152 are connected. By employing the punch having this shape, in the same method as that of the first embodiment, nozzle plate 330 can be manufactured.

As noted above, even with nozzle plate 430 according to the fourth embodiment, outer surface side opening 408a of nozzle 408 will be disposed within top flat surface 405b of swelled portion 405 like in the first embodiment. The grinding time needed to remove the top portions of the protrusions formed in nozzle plate 430 can be shortened. The outer peripheral edge of outer surface side opening 408a of nozzle 408 will be formed to be sharp, even when grinding is performed. Because of that, when ink is discharged from outer surface side opening 408a, the ink drops will be straight from the tips to the rear ends thereof, and the tails thereof will not be curved. The ink discharging direction of each nozzle 408 will be stable and uniformed. An inkjet head having improved print quality can be achieved.

Nozzle 408 of the fourth embodiment has a simple contour in the cross section including centerline Q of nozzle 408. Thus, manufacturing will be simple.

Although preferred embodiments of the present invention were described above, the present invention is not limited to the embodiments described above, and various design modifications are possible within the scope of the claims. In addition, the technological elements described in the present specification or drawings exhibit technological utility either alone or in various combinations, and are not to be limited to the combination of the claims disclosed at the time of application. Furthermore, the technology illustrated in the present specification or drawings achieves a plurality of objects simultaneously, and the achievement of even one object from amongst these has technological utility.

For example, the inkjet head described in the first embodiment is a line type inkjet head, but may also be a serial type inkjet head. In addition, the water-repellent film need not be formed on each nozzle plate 30, 230, 330, 430. Furthermore, the contour of the nozzle in a cross section that includes the centerline of the nozzle may form a shape that has only straight lines that are perpendicular with the outer surface of the nozzle plate. Or, the contour of the nozzle in a cross section that includes the centerline of the nozzle may form a shape that has only straight lines that are non-perpendicular with the outer surface of the nozzle plate. The contour of the nozzles in across section perpendicular to the centerline of the nozzle may form ellipse or circle. In addition, the surface of the periphery portion of swelled portions 105, 205, 305, 405 need not be curved.

In addition, in the aforementioned embodiments, a punch is driven into the metal plate that will become the nozzle plate so that the punch does not penetrate the plate, but the tip of the punch may also penetrate the plate. In this case, a penetrating hole will be form in the plate by driving the punch. When the plate is penetrated with the punch, a swelled portion will be formed on the surface of the plate through which the tip of the punch protrudes outward and around the penetrating hole. The foot of the swelled portion will leave, and the top surface of the swelled portion will be ground to be flat. A nozzle plate in which nozzles are formed to have openings within the top flat surface of the swelled portion can be manufactured by the aforementioned manufacturing method. Because the top flat surface of the swelled portion may be ground flat, the peripheral edges of the openings inside the swelled portion can be formed to be sharp.

In addition, the lapping and polishing process was employed in each of the aforementioned embodiments because the protrusions formed in the nozzle plate are ground, but the present invention is not limited to this process, and may be a method in which precision machining on the flat surface can be performed. For example, a grinding process that can provide a mirror finish. This is a method in which a grinding stone is employed that rotates at a high speed, and which gradually grinds the nozzle plate into a planer surface. The grinding parameters, such as the type stone, the rotational speed, the feed speed, and the depth of the cutting, are adjusted for suitably matched to the characteristics of the plate that will become the nozzle plate. Another method includes a grinding process in which high precision machining can be performed on the post-processing surface roughness and dimensions. This is a process in which unnecessary portions (the top portions of the protrusions) of the nozzle plate are cut off with a blade and removed. The grinding parameters, such as the blade and the shape thereof, the feed rate of the blade, and the grinding speed, are suitably matched to the characteristics of the metal plate that will become the nozzle plate. In addition, and electric discharge method can also be applied. The effects of the present invention will be obtained by employing any of these methods. Furthermore, the effects obtained by the present invention will not have an impact on the system by which the actuator units of the inkjet head operate. The effects of the present invention can be obtained even with an inkjet head having piezoelectric type, thermal type, electrostatic type, or other types of actuator units.

What is claimed is:

1. An inkjet head comprising a nozzle plate, wherein the nozzle plate comprises:
an outer surface, the outer surface facing a printing medium when the inkjet head is in use;
an inner surface opposite to the outer surface;
a swelled portion formed on the outer surface, the swelled portion having a top flat surface; and
a nozzle penetrating the nozzle plate from the outer surface to the inner surface, an opening of the nozzle at the outer surface is disposed within a top flat surface of the swelled portion.

2. An inkjet head as in claim 1, wherein the swelled portion is formed by driving a punch into the nozzle plate from the inner surface toward the outer surface.

3. An inkjet head as in claim 1, wherein the swelled portion gradually changes height from the outer surface of the nozzle plate around the top flat surface.

4. An inkjet head as in claim 1, wherein a contour line of the nozzle in a cross section including a nozzle centerline continues to the inner surface of the nozzle plate without an edge therebetween.

5. An inkjet head as in claim 1, wherein the diameter of the opening of the nozzle at the inner surface is larger than the diameter of the opening, of the nozzle at the outer surface.

6. An inkjet head as in claim 5, wherein a contour line of the nozzle in a cross section including a nozzle centerline includes:
a first curved line extending from the inner surface of the nozzle plate;
a first straight line extending from the first curved line;
a second curved line extending from the first straight line; and
a second straight line extending from the second curved line,
wherein the first straight line extends toward the outer surface of the nozzle plate while approaching the nozzle centerline, the second straight line is perpendicular to the outer surface of the nozzle plate, and the first curved line, the first straight line, the second curved line and the second straight line extend without edges at boundaries therebetween.

7. An inkjet head as in claim 5, wherein a contour line of the nozzle in a cross section including a nozzle centerline includes:
a first curved line extending from the inner surface of the nozzle plate;
a straight line extending from the first curved line; and
a second curved line extending from the straight line,
wherein the straight line extends toward the outer surface of the nozzle plate while approaching the nozzle centerline, the second curved line extends toward the outer surface of the nozzle plate while approaching the nozzle centerline, and the first curved line, the straight line, and the second curved line extend without edges at boundaries therebetween.

8. An inkjet head as in claim 5, wherein a contour line of the nozzle in a cross section including a nozzle centerline includes:
a first curved line extending from the inner surface of the nozzle plate;
a first straight line extending from the first curved line;
a second curved line extending from the first straight line; and
a second straight line extending from the second curved line,
wherein the first straight line extends toward the outer surface of the nozzle plate while approaching the nozzle centerline, the second straight line extends toward the outer surface of the nozzle plate while approaching the nozzle centerline, and the first curved line, the first straight line, the second curved line and the second straight line extend without edges at boundaries therebetween.

9. An inkjet head as in claim 5, wherein a contour line of the nozzle in a cross section including a nozzle centerline includes:
a curved line extending from the inner surface of the nozzle plate;
a first straight line extending from the first curved line; and
a second straight line extending from the first straight line,
wherein the first straight line extends toward the outer surface of the nozzle plate while approaching the nozzle centerline, the second straight line is perpendicular to the outer surface of the nozzle plate, and the curved line and the first straight line extend without edges at boundaries therebetween.

10. An inkjet head as in claim 1, wherein a water-repellent film is formed on the outer surface of the nozzle plate.

11. A method of manufacturing an inkjet head comprising a nozzle plate having an inner surface and an outer surface opposite to the inner surface, the method comprising:
driving a punch into the nozzle plate from the inner surface of the nozzle plate toward the outer surface of the nozzle plate until the tip of the punch proceeds beyond the original outer surface so that a protrusion having an inner space is formed on the outer surface; and
removing a top portion of the protrusion, until the inner space is exposed, to leave a foot of the protrusion and to form a top flat surface having an opening within the top flat surface, thereby forming a nozzle penetrating the nozzle plate with the opening within the top flat surface.

12. A method as in claim 11, wherein the protrusion is formed so that the foot of the protrusion gradually changes height from the outer surface of the nozzle plate.

13. A method as in claim 11, wherein the punch has a tapered shoulder so that a contour line of the nozzle in a cross section including a nozzle centerline continues to the inner surface of the nozzle plate without an edge therebetween.

14. A method as in claim 11, wherein the diameter of the opening of the nozzle at the inner surface is larger than the diameter of the opening of the nozzle at the outer surface.

15. A method as in claim 11, wherein the top portion of the protrusion is removed by lapping and polishing process.

16. A method as in claim 11, further comprising:
coating a photo-curable resin on the outer surface of the nozzle plate to fill a portion of the nozzle at the outer-surface side with the photo-curable resin;
radiating light at the inner surface of the nozzle plate to form a columnar cured resin that fills the portion of nozzle at the outer surface side and extends beyond the outer surface;
removing uncured photo-curable resin on the outer surface;
forming a water-repellent film on the outer surface; and
removing the columnar cured resin.

17. A method as in claim 16, wherein the photo-curable resin is coated so that the thickness of the photo-curable resin is no more than the diameter of the opening of the nozzle at the outer surface.

18. A method as in claim 16, wherein the water-repellent film is formed by an electroplating process.
